(19) United States
(12) Patent Application Publication
(10) Pub. No.: US 2023/0087384 A1
(43) Pub. Date: Mar. 23, 2023

(54) SYSTEMS AND METHODS FOR VIRTUAL CARD GENERATION AND PROVISIONING FOR BULK REQUESTS

(71) Applicant: U.S. Bancorp, National Association, Minneapolis, MN (US)

(72) Inventors: Bradley O. Matthews, Minneapolis, MN (US); Tory K. Passons, Minneapolis, MN (US); Jon C. Zimmermann, Minneapolis, MN (US)

(73) Assignee: U.S. Bancorp, National Association, Minneapolis, MN (US)

(21) Appl. No.: 17/941,332

(22) Filed: Sep. 9, 2022

Related U.S. Application Data
(60) Provisional application No. 63/242,966, filed on Sep. 10, 2021.

(51) Int. Cl. G06Q 20/34; G06Q 20/40

(52) U.S. Cl. CPC G06Q 20/351; G06Q 20/405; G06Q 20/4015

(57) ABSTRACT

The present disclosure describes a method for virtual card generation and provisioning. The method may include receiving a request comprising a list of a plurality of identifiers, the remote computing device transmitting the single request to the processor in response to the remote computing device detecting an event; parsing the list of the plurality of identifiers into a first set of identifiers and a second set of identifiers; retrieving a first restriction policy and a second restriction policy; generating a plurality of virtual cards for the plurality of entities by generating a first set of accounts and a second set of accounts; and linking a first set of virtual cards to corresponding accounts of the first set of accounts and a second set of virtual cards to corresponding accounts of the second set of accounts; and provisioning the generated plurality of virtual cards to the remote computing device.

### CROSS-REFERENCE TO RELATED APPLICATIONS

This application claims priority to U.S. Provisional Application No. 63/242,966, filed Sep. 10, 2021, the entirety of which is incorporated by reference herein.

### BACKGROUND

As companies are relying more and more on commercial travel, their employees may enter into situations in which they are stranded after their return flight is canceled. Common resolutions to this problem often involve the stranded employees visiting an airline service desk and for the airline's computer system to identify a new return flight itinerary for the employee. During this process, an employee may be forced to select a hotel room for the night for a flight that is the next day and send a notification to the employee's company indicating that the company will need to pay for the employee's further travel expenses. The process may require the company to have a verification system that can identify whether the information that the employee is sending the company is accurate. For instance, the company may have a verification system in place that verifies whether the employee had to miss their flight or if it was the employee's fault that he or she had to spend an extra day at the destination. Given how large many companies have grown to be, verifying the employees can cause computers to consume a large amount of computer resources as employees continue to experience issues with their travel.

Airlines may experience a similar problem to such companies when attempting to validate their customers' need for extra accommodation. For example, when an airline's policy is to provide stranded travelers with hotel accommodation and food, the airline may provide the travelers with ticket stubs that the travelers may present to various hotels and/or restaurants as they wait for their next flight. Stranded travelers may present these ticket stubs to hotels and/or restaurants that may or may not have a computer system that is capable of accepting such stubs for payment. Accordingly, the stranded travelers may end up in a situation in which they go from hotel to hotel or restaurant to restaurant seeking an establishment that has a system that is capable of accepting their stubs from the airline.

Furthermore, in some instances, companies may wish to allocate spending stubs to individuals prior to their travel. In one example, a business executive may travel to another state to visit a client and the executive's company may provide a ticket stub to the business executive. The ticket stub may enable the business executive to make purchases at various restaurants and expense the purchases back to the company's accounting system, regardless of the purchase. In this example, the executive's business's authorization system may not be able to approve or verify that the expense should be authorized until after the business executive makes the purchase and uses a computing device (e.g., a cell phone) to transmit a signal back to the company's system indicating the details of the purchase. This verification process can require valuable computer resources as the computing device exchanges signals with the authorization system and the system executes a policy to determine whether to authorize the expense.

### SUMMARY

For the aforementioned reasons, it is desirable to have a computer system that enables companies to provision virtual cards as data packets to individuals that can be used according to the companies' policies. A computer system implementing the systems and methods described herein may provide such benefits by providing an accessible remote device that can generate and provision virtual cards to a company accessing the system. The computer system may receive requests from the company (e.g., the company's computer system) to generate one or more virtual cards for the company that include rules and policies about how, when, and/or where the virtual cards may be used to make purchases. The computer system may generate data packets for the virtual cards and include the rules and policies in the data packets so the virtual cards may only be used in certain situations. Such data packets may be readable as credit or debit cards and may be used at stores that accept debit or credit cards when users wave their mobile device with the stored data packet over a point-of-sale terminal using near-field communication technology. After generating the data packets for the virtual cards, the computer system may transmit the data packets to the requesting company such that the company may provision the data packets to its employees' devices.

Because rules and policies may be coded into data packets for virtual cards, employees of companies that use the systems and methods described herein may be restricted to only using the cards according to the rules and policies on their cards, and the company may not have to use its expense authorization system to authorize any purchases that are made by its employees. Any unauthorized purchases may be restricted at the point-of-sale terminal by a device that stores the respective data packet (e.g., the data packet may not allow the purchase to go through) instead of after the purchase was made. Accordingly, the company may not have to use any processing resources to exchange signals with the employee or verify that the employee's purchases should be expensed and/or the virtual cards may be used in locations in which point-of-sale terminals cannot communicate over a network to confirm purchases by the virtual cards are not restricted.

In some embodiments, instead of storing the rules for transactions that are performed on a virtual card in a data packet for the virtual card, the rules may be stored on a server of the entity (e.g., a bank) that generated the virtual card. In such embodiments, when a transaction is performed using the virtual card, the point-of-sale terminal that conducts the transaction may transmit a signal to the server for transaction approval. The server may access the rules from the profile for the virtual card and either approve or reject the transaction according to the rules. In this way, the systems and methods described herein may restrict transactions that an individual is not authorized to perform while enabling the individual to shop at any store with a system that is capable of accepting standard forms of card payment.

In one aspect, the disclosure describes a method for virtual card generation and provisioning. The method may comprise receiving, by a processor from a computing device, a request to generate a virtual card for a recipient; generating, by the processor, a profile for the recipient based on data from the request, the profile including a card identifier of a virtual card; adding, by the processor, use parameters and an identifier of a virtual card to the profile; provisioning, by the processor, a data packet for the virtual card to the computing device; receiving, by the processor from a transaction device, a transaction request comprising the card identifier of the virtual card and transaction data for a transaction; identifying, by the processor, the profile based on the card identifier; determining, by the processor, the transaction data is in accordance with the use parameters; and transmitting, by the processor, instructions authorizing the transaction to the transaction device in response to determining the transaction data is in accordance with the use parameters.

In another aspect, the disclosure describes a method for virtual card generation and provisioning. The method may include receiving, by a processor from a computing device, a request to generate a virtual card for a recipient, the request comprising one or more use parameters indicating how a generated virtual card may be used; determining, by the processor, the one or more use parameters satisfy a policy; generating, by the processor, a virtual card according to the one or more use parameters in response to determining the one or more use parameters satisfy the policy; and transmitting, by the processor, the generated virtual card to the computing device in response to the request.

In another aspect, the disclosure describes a method for virtual card generation and provisioning. The method may include monitoring, by a processor, a data source for changes to data that is stored within the data source; detecting, by the processor, an event based on a detected change in the data of the data source; identifying, by the processor, individuals associated with the event; generating, by the processor, virtual cards for the identified individuals; and transmitting, by the processor, the generated virtual cards to a computing device, receipt of the generated virtual cards causing the computing device to transmit the generated virtual cards to the respective identified individuals.

In another aspect, the present disclosure describes a method for virtual card generation and provisioning. The method may include receiving, by a processor from a remote computing device, a single request comprising a list of a plurality of identifiers corresponding to a plurality of entities and metadata corresponding to the plurality of identifiers, the remote computing device transmitting the single request to the processor in response to the remote computing device detecting an event based on data stored in a data source, and determining each of the plurality of identifiers has a stored association with the data based on which the remote computing device detected the event; parsing, by the processor from the single request and based on the metadata corresponding to the plurality of identifiers, the list of the plurality of identifiers into a first set of identifiers and a second set of identifiers; retrieving, by the processor from a computer memory, a first restriction policy corresponding to the first set of identifiers and a second restriction policy corresponding to the second set of identifiers; generating, by the processor, a plurality of virtual cards for the plurality of entities by generating, by the processor, a first set of accounts for the first set of identifiers according to the first restriction policy by inserting a first value and a first use restriction into a data structure of each of the first set of accounts, and a second set of accounts for the second set of identifiers according to the second restriction policy by inserting a second value different from the first value and a second use restriction different from the first use restriction into a data structure of each of the second set of accounts; and linking, by the processor, a first set of virtual cards of the plurality of virtual cards to corresponding accounts of the first set of accounts and a second set of virtual cards of the plurality of virtual cards to corresponding accounts of the second set of accounts; and provisioning, by the processor, the generated plurality of virtual cards to the remote computing device, receipt of the generated plurality of virtual cards causing the remote computing device to transmit the plurality of virtual cards to computing devices associated with the plurality of entities.

In another aspect, the present disclosure describes a system. The system may include one or more processors configured by machine-readable instructions to receive, from a remote computing device, a single request comprising a list of a plurality of identifiers corresponding to a plurality of entities and metadata corresponding to the plurality of identifiers, the remote computing device transmitting the single request to the one or more processors in response to the remote computing device detecting an event based on data stored in a data source, and determining each of the plurality of identifiers has a stored association with the data based on which the remote computing device detected the event; parse, from the single request and based on the metadata corresponding to the plurality of identifiers, the list of the plurality of identifiers into a first set of identifiers and a second set of identifiers; retrieve, from a computer memory coupled to the one or more processors, a first restriction policy corresponding to the first set of identifiers and a second restriction policy corresponding to the second set of identifiers; generate a plurality of virtual cards for the plurality of entities by generating a first set of accounts for the first set of identifiers according to the first restriction policy by inserting a first value and a first use restriction into a data structure of each of the first set of accounts, and a second set of accounts for the second set of identifiers according to the second restriction policy by inserting a second value different from the first value and a second use restriction different from the first use restriction into a data structure of each of the second set of accounts; and linking a first set of virtual cards of the plurality of virtual cards to corresponding accounts of the first set of accounts and a second set of virtual cards of the plurality of virtual cards to corresponding accounts of the second set of accounts; and provision the generated plurality of virtual cards to the remote computing device, receipt of the generated plurality of virtual cards causing the remote computing device to transmit the plurality of virtual cards to computing devices associated with the plurality of entities.

In another aspect, present disclosure describes a non-transitory computer-readable storage medium. The non-transitory computer-readable storage medium may have instructions embodied thereon. The instructions may be executable by one or more processors to perform a method. The method may include receiving, from a remote computing device, a single request comprising a list of a plurality of identifiers corresponding to a plurality of entities and metadata corresponding to the plurality of identifiers, the remote computing device transmitting the single request to the one or more processors in response to the remote computing device detecting an event based on data stored in a data source, and determining each of the plurality of identifiers has a stored association with the data based on which the remote computing device detected the event; parsing, from the single request and based on the metadata corresponding to the plurality of identifiers, the list of the plurality of identifiers into a first set of identifiers and a second set of identifiers; retrieving, from a computer memory, a first restriction policy corresponding to the first set of identifiers and a second restriction policy corresponding to the second set of identifiers; generating a plurality of virtual cards for the plurality of entities by generating a first set of accounts for the first set of identifiers according to the first restriction policy by inserting a first value and a first use restriction into a data structure of each of the first set of accounts, and a second set of accounts for the second set of identifiers according to the second restriction policy by inserting a second value different from the first value and a second use restriction different from the first use restriction into a data structure of each of the second set of accounts; and linking a first set of virtual cards of the plurality of virtual cards to corresponding accounts of the first set of accounts and a second set of virtual cards of the plurality of virtual cards to corresponding accounts of the second set of accounts; and provisioning the generated plurality of virtual cards to the remote computing device, receipt of the generated plurality of virtual cards causing the remote computing device to transmit the plurality of virtual cards to computing devices associated with the plurality of entities.

These and other aspects and implementations are discussed in detail below. The foregoing information and the following detailed description include illustrative examples of various aspects and implementations and provide an overview or framework for understanding the nature and character of the claimed aspects and implementations. The drawings provide illustration and a further understanding of the various aspects and implementations and are incorporated in and constitute a part of this specification.

### BRIEF DESCRIPTION OF THE DRAWINGS

The accompanying drawings are not intended to be drawn to scale. Like reference numbers and designations in the various drawings indicate like elements. For purposes of clarity, not every component may be labeled in every drawing. In the drawings:

FIG. 1 is an illustration of a virtual card generation system, in accordance with an implementation;

FIG. 2A is an illustration of a method for virtual card generation and provisioning, in accordance with an implementation;

FIG. 2B is an illustration of another method for virtual card generation and provisioning, in accordance with an implementation;

FIG. 2C is an illustration of another method for virtual card generation and provisioning, in accordance with an implementation;

FIG. 3 is an illustration of a computer environment for virtual card generation and provisioning, in accordance with an implementation;

FIG. 4 is an illustration of a sequence for storing a virtual card in a virtual wallet, in accordance with an implementation;

FIG. 5 is an illustration of a plurality of sequences for generating, accessing, and using a virtual card, in accordance with an implementation;

FIG. 6 is an illustration of a user interface indicating a virtual card has been provisioned to a mobile device, in accordance with an implementation;

FIG. 7 is an illustration of an image of a virtual card on a mobile device, in accordance with an implementation;

FIG. 8 is an illustration of a sequence for generating and provisioning a virtual card, in accordance with an implementation;

FIG. 9 is an illustration of a sequence for generating and provisioning a virtual card, in accordance with an implementation;

FIG. 10A is an illustration of sequences for provisioning a virtual card and determining the virtual card's eligibility to be stored in a digital wallet, in accordance with an implementation;

FIG. 10B is an illustration of sequences for encoding the virtual card into a digital wallet and for generating another virtual card, in accordance with an implementation;

FIG. 11 is an illustration of a user interface for creating a provisioner user profile for provisioning virtual cards, in accordance with an implementation;

FIG. 12 is an illustration of a user interface including a provisioner's user profile, in accordance with an implementation;

FIG. 13 is an illustration of a user interface including settings for provisioning entity, in accordance with an implementation;

FIG. 14 is an illustration of a sequence for provisioning a virtual card to a computing device and storing the virtual card in a digital wallet of the computing device, in accordance with an implementation;

FIG. 15 is an illustration of a user interface for searching users that have virtual cards, in accordance with an implementation;

FIG. 16 is an illustration of the user interface of FIG. 15 with a dropdown for searching users that have virtual cards selected, in accordance with an implementation;

FIG. 17 is an illustration of a user interface that shows information for a virtual cardholder, in accordance with an implementation;

FIG. 18 is an illustration of a user interface that can be used to generate a virtual card, in accordance with an implementation;

FIG. 19 is an illustration of the user interface of FIG. 18 with details for generating the virtual card, in accordance with an implementation;

FIG. 20 is an illustration of a user interface that contains a preview of a virtual card that has been generated, in accordance with an implementation;

FIG. 21 is an illustration of a user interface that includes an email that has been sent to a recipient of a virtual card, in accordance with an implementation;

FIG. 22 is an illustration of a user interface containing information about a provisioned virtual card, in accordance with an implementation;

FIG. 23 is an illustration of a user interface on a mobile device that enables an administrator to generate and provision a virtual card to a user, in accordance with an implementation;

FIG. 24 is an illustration of an example virtual card reconciliation report, in accordance with an implementation;

FIG. 25 is an illustration of a user interface for a virtual card provisioning dashboard that contains information about virtual cards that have been generated and provisioned, in accordance with an implementation;

FIG. 26 is an illustration of a user interface of the virtual card provisioning dashboard of FIG. 25 showing the number of virtual cards that have been created and the number of requests that have been received, in accordance with an implementation;

FIG. 27 is an illustration of a user interface containing virtual card provisioning policy settings for a provisioning entity, in accordance with an implementation;

FIG. 28 is an illustration of a user interface for assigning a role to a profile, in accordance with an implementation;

FIG. 29 is an illustration of a virtual card provisioning dashboard with bulk virtual card generation enabled, in accordance with an implementation;

FIG. 30 is an illustration of a bulk upload file, in accordance with an implementation;

FIG. 31 is an illustration of a user interface containing a list of failed virtual card validations that resulted from a bulk virtual card generation request, in accordance with an implementation;

FIG. 32 is an illustration of a user interface containing accepted virtual card validations that resulted from a bulk virtual card generation request, in accordance with an implementation;

FIG. 33 is an illustration of a user interface containing the approval status of a list of bulk card requests, in accordance with an implementation;

FIG. 34 is an illustration of a method for bulk virtual card generation, in accordance with an implementation;

FIG. 35A is an illustration of a sequence for making a payment using a virtual card, in accordance with an implementation;

FIG. 35B is an illustration of another sequence for making a payment using a virtual card, in accordance with an implementation;

FIG. 35C is an illustration of another sequence for making a payment using a virtual card, in accordance with an implementation;

FIG. 36 is an illustration of another method for virtual card generation and provisioning, in accordance with an implementation;

FIG. 37A is an illustration of a sequence for virtual card generation and provisioning, in accordance with an implementation; and

FIG. 37B is an illustration of a sequence for processing a transaction performed with a virtual card, in accordance with an implementation.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the figures, can be arranged, substituted, combined, and designed in a wide variety of different configurations, all of which are explicitly contemplated and make part of this disclosure.

The embodiments described herein utilize application programming interfaces (APIs) to provision and push virtual cards to a mobile wallet of a third-party network. The embodiments described herein allow clients the ability to send virtual cards with built-in corporate policy parameters to anyone with a business need. These virtual cards can be pushed directly into the end user's mobile wallet for use, all within their own user experience (UX) ecosystem.

The embodiments described herein provide for several specific practical applications. One practical application is a solution to the “stranded traveler” problem. When a traveler has the misfortune of having a flight canceled without another later flight to take the traveler to the intended destination, the traveler is “stranded.” Conventionally, airlines offer a paper voucher for food and/or lodging. However, the paper voucher is a slow and cumbersome way of having an airline pay for expenses by the traveler. A practical application of the embodiments described herein includes pushing a single use tokenized card to an end user's mobile device wallet in real time. The mobile device can provide card available balance and can expedite payment of the expenses.

Another practical application of embodiments described herein is a solution to an online order fulfillment problem. Online orders of items such as groceries are fulfilled by someone picking, paying, and documenting orders for multiple customers. A picker is a person that selects specific groceries corresponding to an order. The process is very manual and introduces mistakes and extra work. A practical application of the embodiments described herein includes pushing a single use card to a mobile device of a picker for each individual order. The single use card supports receipt capture to document purchases and access to digital receipts for improved digital consumer experience.

In one example, virtual cards can be systematically generated upon receipt of a new customer order. For instance, a virtual card can be distributed to a picker on location for the amount of the order. All transactions may then be attributed to the customer or the picker's order and reconciled on a single card account. This may save significant processing steps in delivery of a payment instrument to the picker and may reduce the steps to complete reconciliation on the customer's statement.

Another practical application of embodiments described herein is improving digital wallet experiences. Corporate card programs would benefit from a frictionless, secure, and controllable payment experience. A practical application of the embodiments described herein includes pushing a tokenized card to an end user's mobile device wallet. The tokenized card supports receipt capture, access to digital receipts for reconciliation, and enhanced data for better program management. In addition to frequent travelers and employees, infrequent travelers and non-employees can benefit from applications described herein.

In the context of this disclosure, a digital card is issued electronically, instead of physically as a plastic card, but is otherwise equivalent to a physical card. This enables applications to issue payments via digital card, as well as manage cards and report on their transactions. A digital card may have the following attributes: Card ID; 16-digit Card number; Card Verification Value, or CVV security code; Token ID; Personal Account Number; Expiration date; Credit limit; and Card status. In some embodiments, a digital card may have additional attributes, such as an activation period, rules where it can be spent, custom defined properties, and provisioning details such as employee ID, order ID, travel locator ID, name, phone number, email address, etc. This information may be defined at the time of provisioning and associated with transactions as they are posted to facilitate reconciliation and statements.

### Virtual Card Generation System

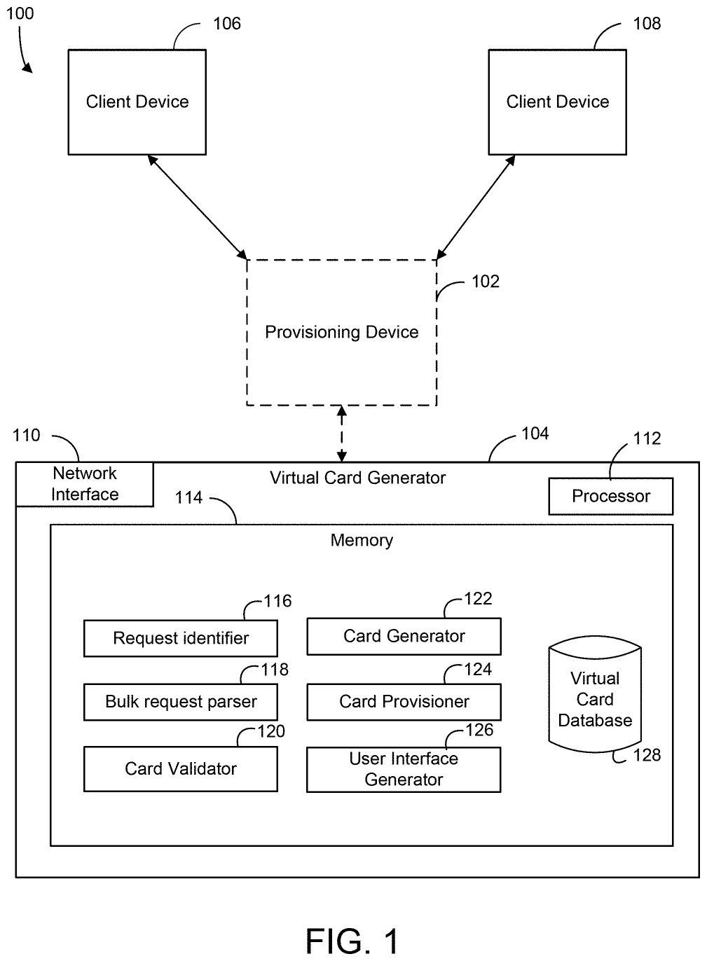

Referring now to FIG. 1, an illustration of an example virtual card generation system 100 is shown, in some embodiments. In brief overview, system 100 can include a provisioning device 102 in communication with a virtual card generator 104 and two client devices 106 and 108 over a network (not shown). These components may operate together such that virtual cards may be generated and provisioned or transmitted to provisioning device 102 and then to client devices 106 and 108. The virtual cards may be or include data packets that enable users of client devices 106 and 108 to make purchases at point-of-sale terminals with the virtual cards using near-field communication technology or scannable codes (e.g., bar codes or QR codes). As described herein a reference to a data packet may be a reference to a virtual card and vice-versa. System 100 may include more, fewer, or different components than shown in FIG. 1. For example, there may be any number of client devices or computers that make up or are a part of virtual card generator 104 and/or the other devices in system 100.

Client devices 106 and 108 and/or virtual card generator 104 can include or execute on one or more processors or computing devices and/or communicate via a network. The network can include computer networks such as the Internet, local, wide, metro, or other area networks, intranets, satellite networks, and other communication networks such as voice or data mobile telephone networks. The network can be used to access information resources such as web pages, websites, domain names, or uniform resource locators that can be presented, output, rendered, or displayed on at least one computing device (e.g., provisioning device 102 or client device 106 or 108), such as a laptop, desktop, tablet, personal digital assistant, smartphone, portable computers, or speaker. For example, via the network, provisioning device 102 may retrieve virtual cards from virtual card generator 104 and transmit the retrieved cards to client devices 106 and 108.

Each of client devices 106 and 108 and/or virtual card generator 104 can include or utilize at least one processing unit or other logic devices such as a programmable logic array engine or a module configured to communicate with one another or other resources or databases. The components of client devices 106 and 108 and/or virtual card generator 104 can be separate components or a single component. System 100 and its components can include hardware elements, such as one or more processors, logic devices, or circuits.

Virtual card generator 104 may comprise one or more processors that are configured to receive requests for virtual cards, generate the requested virtual cards, and transmit the requested virtual cards to the requesting device. Virtual card generator 104 may comprise a network interface 110, a processor 112, and/or memory 114. Virtual card generator 104 may communicate with provisioning device 102 via network interface 110. Processor 112 may be or include an ASIC, one or more FPGAs, a DSP, circuits containing one or more processing components, circuitry for supporting a microprocessor, a group of processing components, or other suitable electronic processing components. In some embodiments, processor 112 may execute computer code or modules (e.g., executable code, object code, source code, script code, machine code, etc.) stored in memory 114 to facilitate the activities described herein. Memory 114 may be any volatile or non-volatile computer-readable storage medium capable of storing data or computer code.

Memory 114 may include a request identifier 116, a bulk request parser 118, a card validator 120, a card generator 122, a card provisioner 124, a user interface generator 126, and/or a virtual card database 128, in some embodiments. In brief overview, components 116-128 may cooperate to generate virtual cards and profiles for various users and provision the virtual cards to provisioning device 102 to forward to various client devices, such as client devices 106 and/or 108. Client devices 106 and/or 108 may receive the virtual cards and store the virtual cards in memory or in a digital wallet. In some embodiments, virtual card generator 104 may transmit the virtual cards directly to client devices 106 and/or 108 as the intended recipients of a virtual card identified in a request. In some embodiments, virtual card generator 104 may store records of the new virtual cards and metadata (e.g., a use history, a credit limit, etc.) about their use in virtual card database 128.

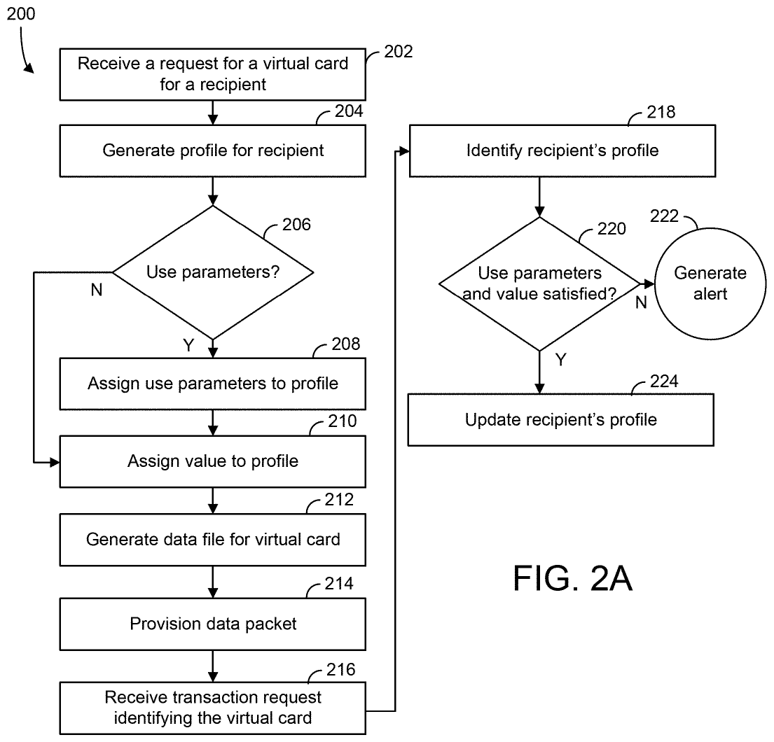

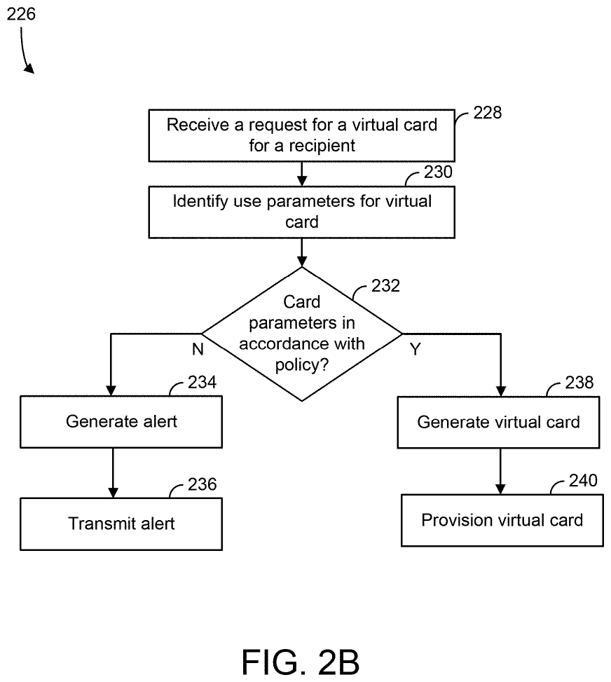

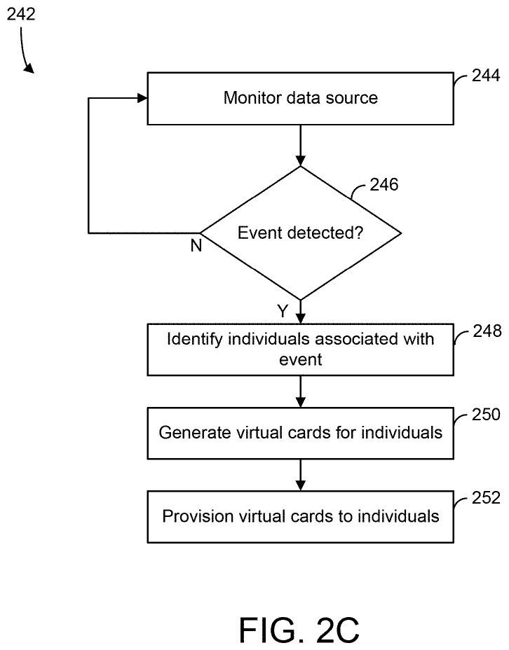

Referring now to FIG. 2A, an illustration of a method for virtual card generation and provisioning is shown, in some embodiments. Method 200 can be performed by a data processing system (a client device, virtual card generator 104, shown and described with reference to FIG. 1, a server system, etc.). Method 200 may include more or fewer operations and the operations may be performed in any order. Performance of method 200 may enable the data processing system to operate as a software-as-a-service system that can receive requests to generate virtual cards, generate the requested virtual cards, and provision the generated virtual cards to the requesting devices. The data processing system may generate the virtual cards such that the cards may be scanned at a point-of-sale terminal or used online to perform transactions. The data processing system may receive a notification of a scanned transaction and either approve or restrict (e.g., stop) the transaction from occurring depending on a policy for the corresponding card's profile. Accordingly, the data processing system may electronically generate and provision cards and determine whether to allow transactions to occur via the provisioned cards.

At operation 202, the data processing system may receive a request to generate a virtual card for a recipient. In some embodiments, the data processing system may receive the request to generate a virtual card from a “provisioning” entity. A provisioning entity may be a group entity such as a company or organization. Such a provisioning entity may use its computing system to request one or more virtual cards from the data processing system. The provisioning entity may then forward the virtual cards to the computing devices owned by various individuals. For example, a company may request five virtual cards from the data processing system that the company can provision to employees that are about to go on a business trip. In some embodiments, the data processing system may receive the request from a mobile device that is operated by an individual user instead of a provisioning entity. For example, via a computing device, a user may transmit a request to the data processing system for a virtual card that the computing device may then store in a wallet application to later make online purchases or purchases at a physical point-of-sale terminal.

In receiving the request, the data processing system may receive data and parameters to use to create the virtual card. For instance, the request may include a name of the recipient, a time frame in which the virtual card will be valid, a maximum spend per transaction, a maximum spend within the time frame or over a predetermined number of transactions, an identifier of the recipient such as an employee identification number, a billing address, contact information such as an email address and/or phone number, notes describing the purpose of the virtual card, etc. In some embodiments, the request may include use parameters or rules indicating when, where, and/or how the virtual card can be used by the individual. For instance, the request may include parameters that indicate times of the day the virtual card can be used, specific stores in which the virtual card may be used, categories of items or stores for which the card may be used, etc. The request may include any number of parameters or rules.

In some embodiments, the request may be a bulk request to create virtual cards for multiple individuals. The bulk request may include information that the data processing system can use to generate virtual cards for the individuals. For instance, in one request, the data processing system may receive identifications of multiple individuals and information for each individual to use to create or generate virtual cards. In some embodiments, such requests may include a spreadsheet that includes the data to include for the virtual cards included in rows that each correspond to a different virtual card. In some embodiments, the requests may be data that was input into forms on an application (e.g., a web application). The request may include the same or different rules or parameters between the requested virtual cards.

At operation 204, the data processing system may generate a profile for the recipient (e.g., the individual for which the virtual card is being generated). The data processing system may generate the profile by retrieving information about the recipient from the request and populating a profile with the information. For example, the data processing system may retrieve the information about the recipient from the request and update attribute-value pairs of a data structure that corresponds to the profile with the information to individually identify the recipient. The data structure may be stored in a database so the data processing system can retrieve information from the data structure. For instance, in some embodiments, the data processing system may store rules and parameters indicating when, where, and/or how the respective virtual cards can be used to facilitate transactions. The data processing system may store the rules and parameters in rule attribute-value pairs in the data structure.

In some embodiments, the profile may include information about the virtual card that the data processing system is generating. For example, when generating the virtual card, the data processing system may generate a numerical string that individually identifies the virtual card using various techniques such as pseudo-random number generation. The data processing system may also generate a second numerical string that can be used as a security code for the virtual card. The data processing system may store each of these numerical strings in the profile for the virtual card. These numbers may be used to call and look up the profile when the virtual card is used to facilitate a transaction.

In embodiments in which the data processing system receives a bulk request to generate multiple virtual cards, the data processing system may individually identify the information for each virtual card and generate profiles for the virtual cards accordingly. For example, the request may include a request to generate a virtual card for John Doe and a virtual card for Jane Doe. The request may include information that corresponds to each individual as described above. The data processing system may generate a profile for John Doe and a profile for Jane Doe using the corresponding information in the request. The data processing system may generate any number of profiles based on one request and continue to generate profiles for individuals as the data processing system continues to receive requests.

At operation 206, the data processing system may determine if the request includes any use parameters. As described above, use parameters may be the rules or parameters that indicate whether individual transactions can be completed. Such requests may be useful for a provisioning entity that wishes to control when, where, and/or how its employees or members use the virtual cards that the provisioning entity provisions to them. The data processing system may determine if the request includes use parameters by parsing the data from the requests and determining if the parsed data includes any use parameters.

In one example, a company may request a virtual card that can only be used once. To do so, the company may include a transaction limit in the use parameters that the company includes in the request along with any other use parameters that the company may include (e.g., a credit limit or a limit on the types of goods that may be purchased). Thus, the company may request virtual cards for its employees to make single use orders for spur of the moment needs of the company.

In some embodiments, the data processing system may determine if the request includes use parameters on a recipient by recipient basis. For instance, if the data processing system receives a bulk request from the provisioning device to generate multiple virtual cards, the data processing system may evaluate the data for each virtual card to determine if any of the virtual cards have use parameters in its respective data.

Responsive to the data processing system determining the request includes a use parameter for at least one virtual card, at operation 208, the data processing system may assign the use parameter to the respective profile. To do so, the data processing system may update a rule attribute-value pair of the profile to include the use parameter by adding values to the rule attribute-value pair. Values of use parameters may be machine-readable strings that the data processing system may read and enforce as a policy when enabling transactions with the virtual card. For example, the value may be the string “hotel” that indicates the virtual card may only be used to purchase hotel stays. Other examples of values include, but are not limited to, “restaurant” which may indicate the virtual card may only be used for restaurant purchases, “New York City” which may indicate the virtual card may only be used for purchases within New York City, and “5 PM to 9 PM” which may indicate the card may only be used for purchases between 5 PM and 9 PM. Such values may be added to generic rule attribute-value pairs or to rule attribute-value pairs that are specific to the type of the rule (e.g., a rule attribute-value pair may be specific to the location the virtual card can be used, the times the virtual card can be used, the types of purchases for which the virtual card can be used, etc.). The profiles may include multiple rule attribute-value pairs for one rule type and/or multiple rule type attribute-value pairs. The data processing system may add use parameters to any number of profiles that are generated as a result of a request.

At operation 210, the data processing system may assign a value to the profile. The value may be a limit (e.g., a credit limit) to how much can be spent with the virtual card (e.g., 50 dollars) on a per-transaction basis, within different time intervals, or for the entire use of the virtual card. As described herein, a value may be a use parameter. The data processing system may assign the value to the profile by retrieving the value from the request and adding the value to a value attribute-value pair of the profile. In some cases, the data processing system may add values to each of the different limits depending on the data received in the request. For example, the data processing system may add a value to a value attribute-value pair that provides a limit for individual transactions, a value to a value attribute-value pair that provides a limit for different time intervals, and/or a value to a value attribute-value pair that provides a limit for the entire use of the virtual card. Thus, a provisioning entity that requests the virtual cards may have greater control over the spending of the recipients of the virtual cards. The data processing system may similarly assign values to any number of profiles for which a virtual card is generated.

At operation 212, the data processing system may generate a data packet for the requested virtual card. The data processing system may generate the data packet to include the information that is included in the corresponding profile and the original virtual card request. For example, the data packet may include a name of the intended recipient for the virtual card, any spending limits, and a time period for which the virtual card will be active. The data packet may also include other information about the virtual card such as a card number of the virtual card and a card security code. In some embodiments, the data packet may include an image that represents the virtual card and may appear to indicate the virtual card that is being scanned at a point-of-sale terminal to facilitate a transaction. The data processing system may generate any number of data packets in response to requests for virtual cards.

In some embodiments, the data processing system may include the use parameters for the virtual card in the data packet. For example, if the request for a virtual card includes a spending limit, the data processing system may include the spending limit in the data packet for the virtual card. Such rules may be enforced by an application stored on the eventual recipient's computing device such that the virtual card that corresponds to the data packet may only be used according to the rules stored in the data packet. Advantageously, by including the rules in the data packet that is eventually transmitted to the recipient device, the device may avoid transmitting any signals to the data processing system and may instead locally verify that the transaction is in accordance with the policy established by the entity that requested the virtual card.

At operation 214, the data processing system may provision the data packet to the requesting device. The data processing system may provision the data packet to the requesting device by transmitting the data packet to the device, in some cases after encrypting the data packet for added security. For example, if an individual requests a virtual card for his or her own personal computing device, the data processing system may transmit a data packet for the requested virtual card to the personal computing device such that the individual may store and use the virtual card to facilitate transactions. If a provisioning entity is requesting one or more data packets to send to other individual computing devices, the data processing system may transmit data packets for the requested virtual cards to the provisioning entity. The provisioning entity may receive the data packets and forward the data packets to the computing devices of the recipients for which the virtual cards were requested.

In some embodiments, the provisioning entity may forward the requested data packets to a dedicated application of the provisioning entity. For example, if a company, Acme Co., requests 10 virtual cards for its employees, the data processing system may generate and provision 10 virtual cards to Acme Co.'s system and then Acme Co. may distribute the virtual cards to 10 of its employees via an Acme Co. application that is stored on their respective computing devices. In doing so, Acme Co. may use a pre-established connection its system has with the application on their devices, helping to avoid using any computing resources that would be required to establish a new connection to transmit the data packets for the virtual cards.

In some embodiments, upon receiving the data packets for the virtual cards, the individual devices may push the data packets into digital wallets that the devices have stored in memory. For instance, each of the devices may have a digital wallet that stores virtual cards for different group entities and companies. The digital wallets may be in communication with the provisioning entity's application so the application may store the data packets for the virtual cards in the recipients' respective wallets. Because such digital wallets are often secure, storing the data packets for the virtual cards in the digital wallets may improve security for the requested cards (e.g., make the virtual cards less likely to be accessed by malicious parties).

At operation 216, the data processing system may receive a transaction request identifying the provisioned virtual card. The transaction request may include the virtual card's number and/or the virtual card's security code. The transaction request may also include details for the transaction such as a total cost, the group entity with which the transaction is being conducted, the items that are being purchased in the transaction, etc. The data processing system may receive the request from the computing device that stored the provisioned virtual card or from the computing system on the other side of the transaction (e.g., the computing system that operates the point-of-sale terminal or operates the website for which the virtual card is being used to make a purchase).

At operation 218, the data processing system may identify the recipient's profile that corresponds to the provisioned virtual card. The data processing system may do so by searching the database that includes profiles for various virtual cards using the virtual card's number (or an equivalent, e.g., a token) as a key. In some cases, the data processing system may not be able to identify a profile that corresponds to the provisioned virtual card. In such cases, the data processing system may generate an alert indicating no profile could be found and send the alert back to the device that sent the transaction request indicating the transaction cannot be completed.

If the data processing system is able to identify the recipient's profile, at operation 220, the data processing system may determine if any use parameters within the profile are satisfied. The data processing system may do so by comparing the transaction data included in the transaction request to the use parameters in the rule attribute-value pairs. For example, the data processing system may identify the other entity that is a part of the transaction from the transaction data (e.g., identify an identifier of the company from which the recipient making a purchase in the transaction data of the transaction request). The data processing system may compare the identifier to the use parameters to determine if the entity is a part of any list that identifies with which the virtual card may be used in a transaction or if the entity is restricted by another criteria or use parameter. In another example, the data processing system may determine an entity type (e.g., grocery store, restaurant, hotel, gas station, etc.) of an entity by comparing an identifier for the entity to identifiers in a look-up table. The data processing system may determine if the determined entity type is in accordance with the stored use parameters in the recipient's profile by comparing the entity type to the use parameters. In another example, the data processing system may identify the location of the transaction and determine if the location fails to satisfy any use parameters. The data processing system may determine the location of the transaction either based on the entity identifier (e.g., by comparing the entity identifier to a look-up table containing the locations for various group entities) or based on geolocation coordinates of the recipient's device (e.g., upon receiving an indication of a transaction, the data processing system may send a location request to the recipient's device and the recipients may respond with the geolocation information). The data processing system may compare the location information to use parameters of the recipient's profile to determine if the location information fails to satisfy any use parameters. In another example, the data processing system can determine the items being purchased have been designated as purchasable or non-purchasable in the use criteria of the profile. The data processing system may use any number of criteria and use parameters such as to determine if all the use parameters of the recipient's profile are satisfied. In another example, the data processing system may determine the location and merchant of the transaction.

In addition to determining whether the use parameters of the recipient's profile were satisfied, the data processing system may also determine if the value of the recipient's profile was satisfied by the value of the transaction. For instance, the data processing system may compare the value of the transaction to the values of the value-attribute pair of the transaction. The data processing system may compare the value to the value assigned to the profile to confirm the value of the transaction does not exceed the value assigned to the user account (e.g., the transaction does not exceed a spending threshold). In some embodiments, the data processing system may compare the value to multiple values that correspond to different spending limits such as the total amount an individual is allowed to spend in a single transaction or the total amount an individual is allowed to spend within a set time period. The data processing system may compare the value to any number of values that have been assigned to the recipient's profile.

If the data processing system determines one or more use parameters and/or values are not satisfied, at operation 222, the data processing system may generate an alert indicating the transaction cannot be completed. The data processing system may transmit the alert to the device that transmitted the original transaction request to stop or restrict the transaction from being completed. Thus, the data processing system may avoid allowing a user to complete transactions that are against the provisioning entity's policy.

However, if the data processing system determines the use parameters and value are satisfied, at operation 224, the data processing system may update the recipient's profile to indicate the transaction occurred. For instance, the data processing system may update the profile with the value (e.g., the cost) of the transaction by indicating the recipient has less to spend on the card. The data processing system may also add the transaction data for the transaction to a transaction history that indicates the previous transactions into which the recipient has entered. The data processing system may generate and send an alert to the device that sent the transaction request and/or the recipient's device to indicate the transaction was successful. Thus, the data processing system may facilitate transactions via virtual cards that the data processing system generates and provisions to provisioning entities and individual users.

In some embodiments, after a recipient receives a virtual card from a provisioning entity, the provisioning entity may monitor the recipient's use of the virtual card. For example, the provisioning entity may have a profile setting in its profile within the data processing system that causes any transactions that are performed with virtual cards that it provisions to cause transaction notifications to be sent to the provisioning entity's system. In another example, the provisioning entity may transmit requests to the data processing system asking for data about transactions that are performed with provisioned virtual cards. The provisioning entity may transmit such requests at defined intervals after provisioning the virtual cards to different individuals. The data processing system may respond with data about any transactions that the virtual cards have performed in response to such requests.

In some embodiments, the provisioning entity's system may adjust the use criteria for individual virtual cards based on the data that it receives about transactions performed using the respective virtual card. For example, the provisioning entity's system may receive data indicating that a virtual card with a 30 dollar credit limit was used to buy a 25 dollar lunch. The provisioning entity's system may update the use criteria to either increase the credit limit so the individual has a credit limit to pay for dinner or reduce the credit limit to avoid the individual from using the remaining limit for further purchases. The provisioning system may transmit instructions to the data processing system to change the use parameters accordingly and the data processing system may update the profile for the virtual card or transmit instructions to the computing device in which the virtual card is stored to update the use parameters in the data packet for the virtual card.

In some embodiments, the data processing system may adjust the use parameters in profiles for virtual cards based on requests the data processing system receives from the provisioning entity's system. For example, the data processing system may generate a profile for a virtual card that includes a use parameter that indicates the virtual card may only be used at a hotel for a single transaction of less than $50. The data processing system may generate the profile in response to receiving a request from a computer owned or accessed by a provisioning entity. After generating the profile and provisioning the virtual card that corresponds to the profile to the computer of the provisioning entity, the data processing system may receive a modification request from the computer of the provisioning entity. The modification request may be a request to change a use parameter in the profile. For instance, the modification request may be a request to change the locations in which the virtual card may be used to perform transactions, the number of transactions the virtual card may be used to perform, the total transaction amount the virtual card for which the virtual card may be used, and/or any other use parameters. The data processing system may receive the request, identify the profile in which to make the modifications based on a virtual card identifier in the request, and adjust or add to the use parameters in the profile according to the request (e.g., insert the use parameters from the request into the profile and/or replace use parameters currently stored in the profile with use parameters of the same type in the modification request). In some embodiments, the data processing system may only modify the use parameters in the profile in response to determining the modification request originated at a computing device of the same provisioning entity as the provisioning entity for which the data processing system generated the profile (e.g., determining the modification request originated from the same IP address as the IP address of the computer that sent the request to generate and provision the virtual card, or determining the account that transmitted the modification request from the same registered account with the data processing system as the account that requested the virtual card to be generated and provisioned). In this way, the data processing system may enable provisioning entities to reconfigure profiles for virtual cards in real time after the profiles are generated.

Referring now to FIG. 2B, an illustration of a method 226 for virtual card generation and provisioning is shown, in some embodiments. Method 226 may be performed by a data processing system (e.g., virtual card generator 104). Method 226 may include any number of operations and such operations may be performed in any order. At operation 228, the data processing system may receive a request for a virtual card for a recipient. The request may include information about the recipient and use parameters indicating how, when, and/or where the virtual card can be used to make purchases. At operation 230, the data processing system may identify the use parameters from the request.

At operation 232, the data processing system may determine whether the use parameters are in accordance with a defined policy. The data processing system may do so using a rule-based system, a machine learning or artificial intelligence-based system, or through a manual approval process. For example, if the data processing system is configured to use a rule-based system, the data processing system may store a series of rules in a database or otherwise in memory. The rules may include card generation criteria related to the use parameters that are included in the virtual card request. For example, one rule may be a credit limit threshold indicating a maximum amount of credit that may be requested for a single virtual card. Another rule may indicate that virtual cards may only be provisioned for users that are located in, or are traveling to, a specific geographic location and/or specific locations or destinations of users for which the cards cannot be provisioned.

In some embodiments, card generation criteria rules may be related to the account requesting the virtual cards. For example, one rule may indicate that an account may only request a certain number of cards or make a certain number of requests within a defined time frame. Another rule may be a limit to the number of virtual cards a user may request in a single bulk request. The data processing system may store any number of rules as a policy to determine whether to validate a request to generate and provision one or more virtual cards.

In some embodiments, the rules and/or policies may be specific to a provisioning entity (e.g., a company for which the virtual cards are generated and provisioned). For example, different provisioning entities may have different time frames and/or thresholds for use parameters and/or rules for provisioner user accounts. Such rules may be established or set up by the provisioning entities themselves or by an administrator of the data processing system.

If the data processing system is configured to use a machine learning or artificial intelligence-based system (herein described as a machine learning system), the data processing system may train a machine learning model (e.g., a neural network, random forest, support vector machine, etc.) to predict whether to approve or validate requests for virtual cards. To do so, the data processing system may use a supervised learning training method in which the data processing system inputs card parameters and metadata about requests (e.g., number of requests made by a requesting provisioner (in some cases within a recent time frame), number of approved requests made by the requesting provisioner, number of rejected requests made by the requesting provisioner, number of virtual cards that are being requested, other requests that have been approved by members of the same team as the requesting provisioner, etc.) into a machine learning model. The data processing system may transmit an output prediction to a computing device and receive a prediction label (e.g., approved or rejected) for the inputs. The data processing system may then use backpropagation techniques and a loss function based on the output and the prediction label to update the weights and parameters of the machine learning model to make more accurate predictions for future inputs. The data processing system may perform this training process in real-time as provisioning entities request virtual cards and/or before the machine learning model is used. In the latter case, the data processing system may determine an accuracy of the machine learning model as it is trained (e.g., based on the difference between a prediction and a prediction label) and only use the machine learning model to predict whether to approve requests once the machine learning model is trained above an accuracy threshold.

If the data processing system is configured to use a manual approval process to validate requests for virtual cards, an individual with an approver role may manually review the request and the use parameters in the request and provide an input into a user interface to indicate whether the request is approved or denied. In some embodiments, the data processing system may be configured to use a machine learning-based system, rules, and/or triggers to determine if a virtual card may be generated and/or provisioned automatically or if the card requires a secondary manual approval from an approver. For instance, the data processing system may evaluate use criteria of a requested virtual card using a machine learning model, rules, or triggers. Based on the evaluation, the data processing system may determine if the card requires manual review from an approver or may be generated immediately. In one example, the data processing system may use the rule-based system or the machine learning-based system to validate requests unless the use criteria in a request satisfies a specific rule (e.g., a credit limit that exceeds a threshold). In this case, the data processing system may send the data from the request to a manual reviewer to ensure the approval is accurate in special cases.

For bulk requests, the data processing system may separately perform operation 232 for the use criteria of each individual virtual card and/or for all of the requested cards. For example, the data processing system may validate each individual card in a request based on the criteria for the card using the methods described above. The data processing system may additionally or instead evaluate the cards together using the methods described above and/or based on metadata about the bulk request (e.g., number of virtual cards requested, number of requests received from the requesting entity within a predetermined time frame, etc.). Accordingly, the data processing system may validate or deny validation for individual cards of a bulk request to account for the different use criteria that may be set for each card and the provisioner that is making the request.

If the data processing system determines the card parameters are not in accordance with policy, at operation 234, the data processing system may generate an alert indicating a virtual card could not be generated. At operation 236, the data processing system may transmit the alert to the device that requested the virtual card to indicate the card could not be created and the reasons the card could not be created. In the case of a bulk request, the data processing system may identify the individual virtual cards that could not be created and the reasons the virtual cards could not be created.

However, if the data processing system determines the card parameters are in accordance with policy in operation 232, at operation 238, the data processing system may generate a virtual card according to the use parameters. At operation 240, the data processing system may transmit the generated virtual card to the requesting device. In the case of a bulk request, the data processing system may generate each validated virtual card of the bulk request and transmit the validated virtual cards to the requesting device.

Referring now to FIG. 2C, an illustration of a method 242 for virtual card generation and provisioning is shown, in some embodiments. Method 242 may be performed by a data processing system (e.g., virtual card generator 104). Method 242 may include any number of operations and such operations may be performed in any order. At operation 244, the data processing system may monitor the data source. The data processing system may monitor a data source by identifying any new records or notifications that are generated in the data source. For example, the data source may be a database that indicates the flight status of one or more flights that are operated by an airline. The data source may indicate whether various flights are on time, early, late, or canceled. The data processing system may identify the status of the flights over time to monitor the data source. Other example data sources may be email databases for provisioning entities, calendars of individuals, electronic directories, etc.

At operation 246, the data processing system may determine if an event was detected. An event may be a defined event in a database of the data processing system such as an airline cancellation. A detected event may be an indication to generate a virtual card to provision to individuals affected by the event. For example, if a flight is canceled for an airline, the data processing system may detect the flight cancelation from the data source that the data processing system is monitoring. In another example, the data processing system may detect an event when it determines that a passenger is unlikely to make a flight on a layover. From the data source, the data processing system may determine the times a particular passenger is scheduled to arrive at an airport on a flight and a time of the layover. The data processing system may determine if the interval between the two times is less than a threshold by comparing the length of the interval to the threshold. If the data processing system determines the person is likely to miss the next flight, the data processing system may determine an event occurred. In another example, the data processing system may monitor a person's electronic calendar or email and detect an event when the person schedules a trip.

In some embodiments, the data processing system may detect an event upon executing a machine learning model and predicting an individual may need a virtual card. For example, the data processing system may extract calendar data and/or data from emails for individual user accounts. In some embodiments, the data processing system may extract past card provisions and payment history as well as future events such as subscription or rental expirations, maintenance schedules, etc. The data processing system may input the extracted data into a machine learning model that has been trained to predict instances in which individuals will need a virtual card (e.g., when a provisioning entity would normally provision the individual any virtual cards). For instance, the machine learning model may be trained to predict that individuals will likely need virtual cards when they have a scheduled flight coming up or when a seminar or symposium that individuals normally attend is scheduled to occur. The machine learning model may be trained using a supervised training method similar to the training described above with respect to the machine learning model that predicts whether to approve requests to generate and provision virtual cards. After the machine learning model is sufficiently trained to an accuracy threshold, the data processing system may continuously feed the machine learning model with data from the monitored data source at set time intervals to determine when events occur.

At operation 248, the data processing system may identify the individuals that are associated with a detected event. The data processing system may do so on a case-by-case basis depending on the detected event. For example, if the data processing system detects the event by detecting that one or more people missed or will likely miss a flight, the data processing system may identify the individuals from the data source that the data processing system used to detect the event. If the data processing system detects the event from an individual's calendar or email inbox, the data processing system may identify the individual as the owner or person associated with the calendar or email inbox. If the data processing system detects the event from a directory or list of people scheduled to attend an event, the data processing system may identify the individuals from the list. The data processing system may identify the individuals in any manner.

At operation 250, the data processing system may generate virtual cards for the individuals that were affected by the event. The data processing system may do so using predetermined use criteria that is associated with the event. For example, the data processing system may determine the event as a missed plane flight or a potential missed plane flight. The data processing system may identify use criteria that has a stored association with the missed plane flight or potential missed plane flight (e.g., money for a one night's hotel stay and for two meals) and generate the virtual cards with the use criteria. The data processing system may also include information about the individuals for which the data processing system is generating virtual cards such as name, address, contact information, etc., in the virtual cards (e.g., in the data packet for the virtual cards). The data processing system may identify the information for the individuals from the data source from which the data processing system collected information to detect the event.

At operation 252, the data processing system may provision the generated virtual cards to the individuals. The data processing system may provision the generated virtual cards to the individuals by transmitting data packets containing the virtual cards to the devices of the individuals. Such devices may be identified from an application the individuals have on their devices. In some embodiments, the data processing system may transmit an email to accounts of the individuals and the individuals may retrieve the virtual cards from the emails. The data processing system may retrieve the information to use to send the virtual cards to the individuals from the data source from which the data processing system collected data to detect the event and/or by cross-referencing information in such a data source with an internal database of the data processing system. Thus, the data processing system may be able to automatically provision virtual cards to individuals over time without waiting for any requests, significantly reducing any latency that results from a user submitting a request for a virtual card that may require the system to take time to process and/or validate the request.

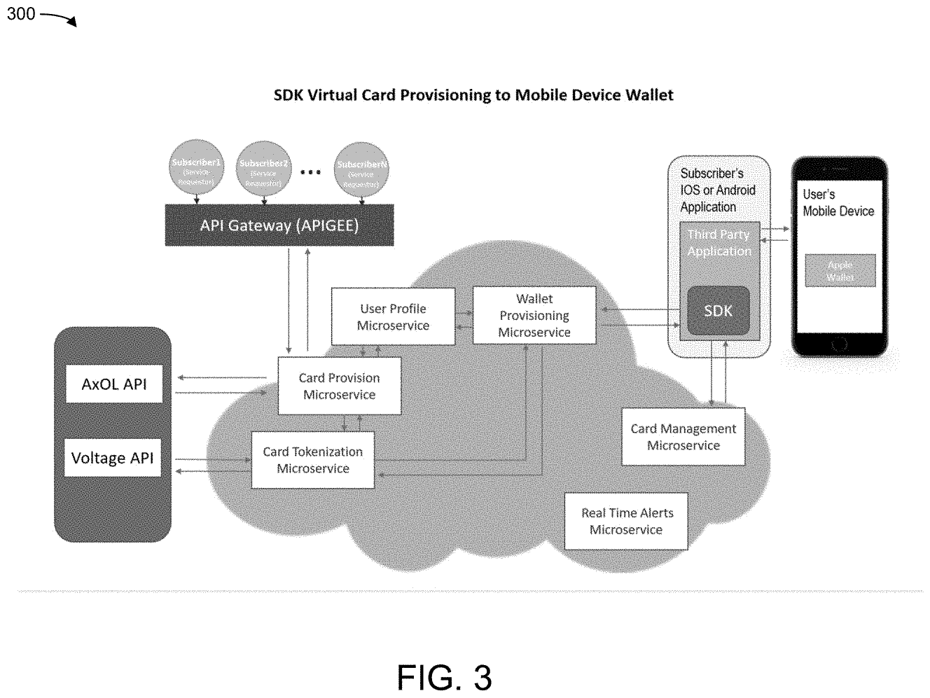

Referring now to FIG. 3, an illustration of a computer environment 300 for virtual card generation and provisioning is shown, in some embodiments. In computer environment 300, a data processing system operating in computer environment 300 may receive a request to generate one or more virtual cards from a provisioning entity. In response, the data processing system may use a series of microservices to generate and provision the virtual cards to a provisioning entity's application. The application may then transfer the virtual cards to the computing devices of various individuals for storage in their digital wallet. The individuals may later use the virtual cards to make online purchases or purchases in brick and mortar stores.

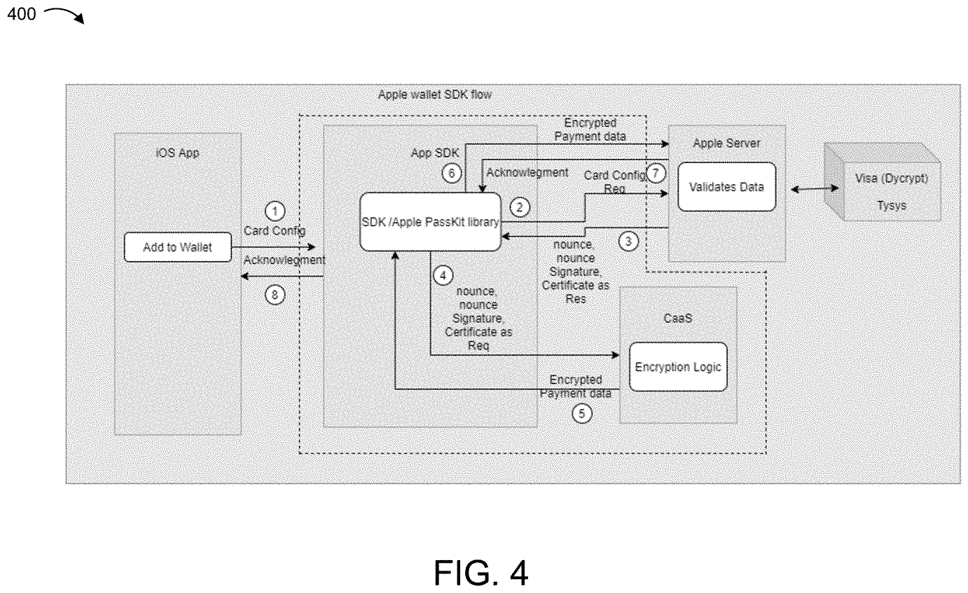

Referring now to FIG. 4, an illustration of a sequence 400 for storing a virtual card in a virtual wallet is shown, in some embodiments. Sequence 400 may include an application that receives a request to add a virtual card to a wallet in the application. The application then communicates with a software developer kit with data for a virtual card being added to the wallet. The software development kit then communicates with a validation server to validate that the data for the virtual card may be stored in the digital wallet and then an encryption server that uses encryption logic to encrypt the data of the virtual card so the virtual card can be stored.

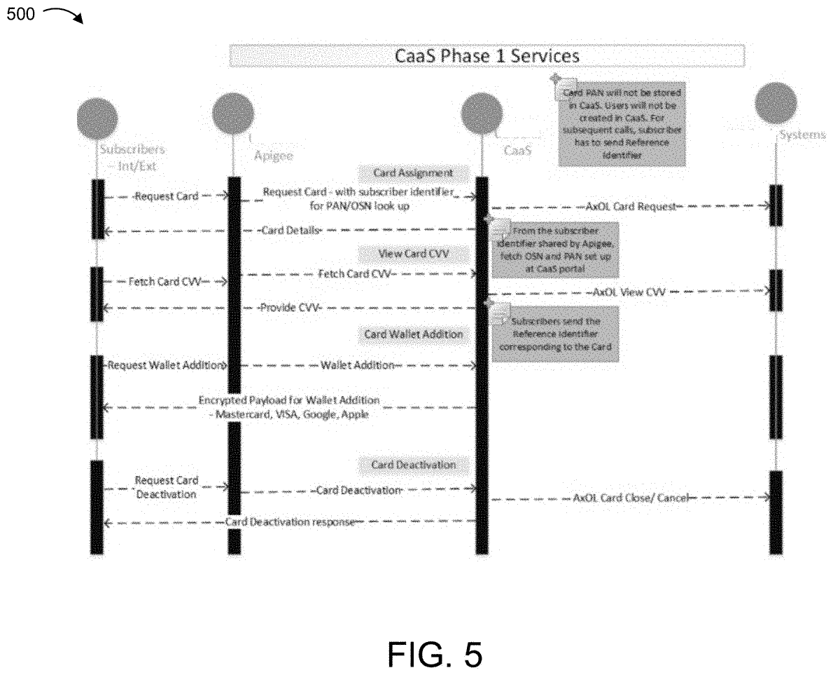

Referring now to FIG. 5, an illustration of a plurality of sequences 500 for generating, accessing, and using a virtual card is shown, in some embodiments. Sequences 500 may include a sequence for assigning a virtual card to a specific subscriber (e.g., a provisioning entity) with a subscriber identifier, a sequence for viewing information about the card such as the card security code based on the subscriber identifier, a sequence for adding the virtual card to a digital wallet, and a sequence for deactivating the virtual card.

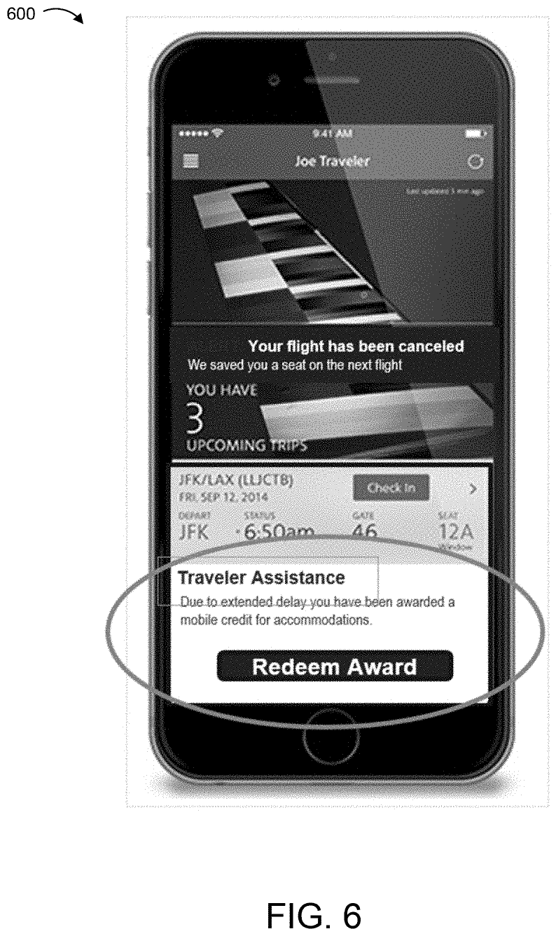

Referring now to FIG. 6, an illustration of a user interface 600 indicating a virtual card has been provisioned to a mobile device is shown, in some embodiments. User interface 600 may be presented to a user after a data processing system determines an event such as a missed layover or a canceled flight has occurred that may require the user to need accommodations while waiting for a new flight to the user's final destination. For example, the user may be in Indiana on a business trip with a planned return flight home to Seattle. The return flight may be canceled for technical reasons or because of the weather, and the next flight to Seattle may not be until the next day. The airline responsible for the user's return flight may have a system that implements or uses the systems and methods described herein and be able to identify that the traveler will need accommodations upon detecting that the user's flight was canceled and that the user will need to stay in Indiana an extra day. Accordingly, the system may automatically request a virtual card with various parameters indicating a limit the user can spend and that the card may only be used for hotel and restaurant accommodations. The system may receive the virtual card and transmit the virtual card to the user's device, causing a notification to appear at the user's device that the virtual card has been delivered and/or that the virtual card has been stored in the device's digital wallet. The user may use the virtual card at various hotels and restaurants until his or her flight the next day without requiring going to a service desk or traveling from hotel to hotel or restaurant to restaurant seeking an establishment that accepts stubs that are typically provided by airlines in similar situations.

In some embodiments, the use parameters that are set for a virtual card may be based on the user's need and the specific scenario (e.g., amount, activation period, where it can be used, and frequency). For example, if a traveler is scheduled to be stranded for multiple days, the credit amount for the traveler's virtual card may be larger than the credit amount for a passenger that is stranded in the same location for one day. In some embodiments, the credit amount and other use parameters may be determined based on a traveler's stored status. For example, a traveler may have a virtual card profile that indicates he or she has an elevated status, thus causing virtual cards that are provisioned to the traveler's virtual wallet to have a higher credit limit than travelers without the elevated status. In this way, the described system may ensure greater control, security, and reduced costs of provisioning virtual cards to stranded travelers.

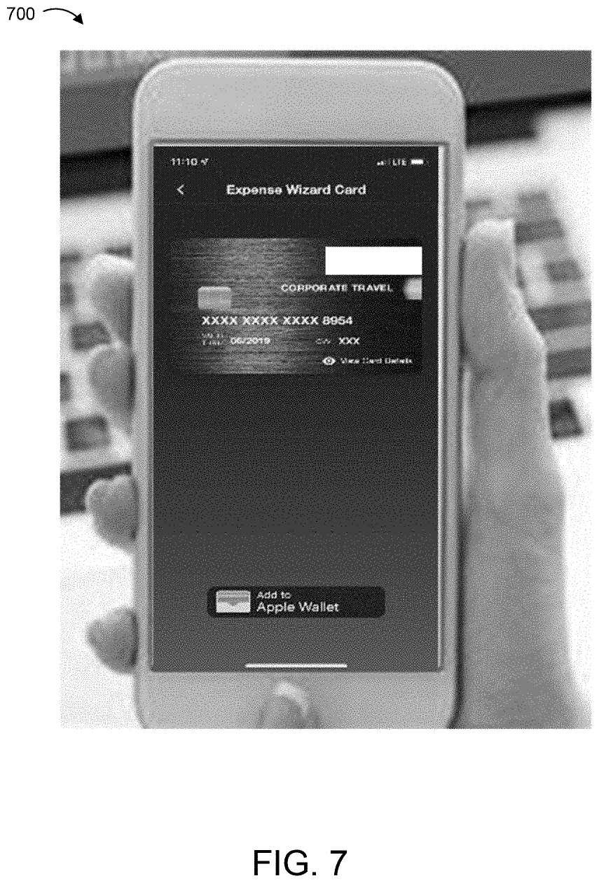

Referring now to FIG. 7, an illustration of an image 700 of a virtual card on a mobile device is shown, in some embodiments. The virtual card may be scanned at a point-of-sale terminal to make purchases or used to make online purchases per any use parameters that have been assigned to the card.

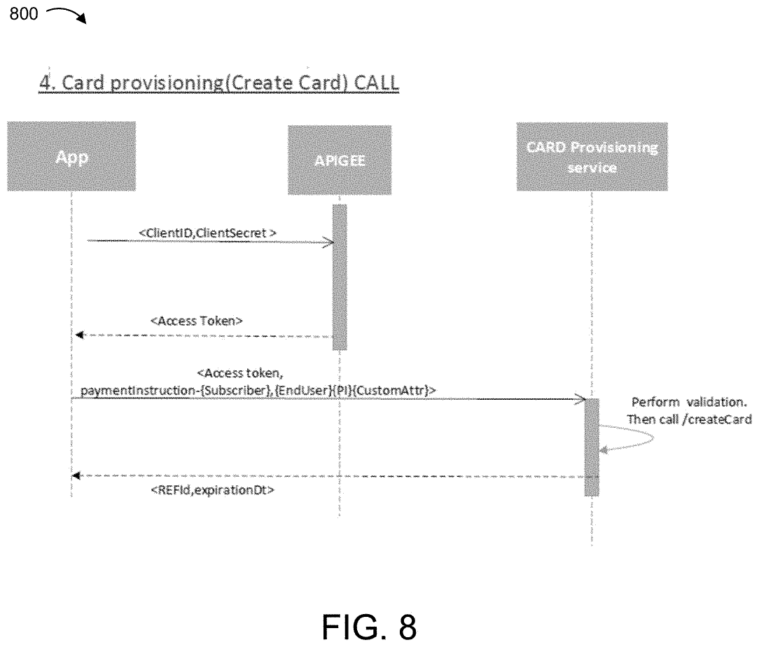

Referring now to FIG. 8, an illustration of a sequence 800 for generating and provisioning a virtual card is shown, in some embodiments. As illustrated, an application may access a virtual card provisioning service via an API. The application may send the card provisioning service data including an access token, payment instructions, a subscriber identifier (e.g., a provisioning entity identifier), and information about the final recipient of the virtual token. The card provisioning service may receive the request, generate a virtual card based on data in the request, and then transmit the virtual card back to the requesting application.

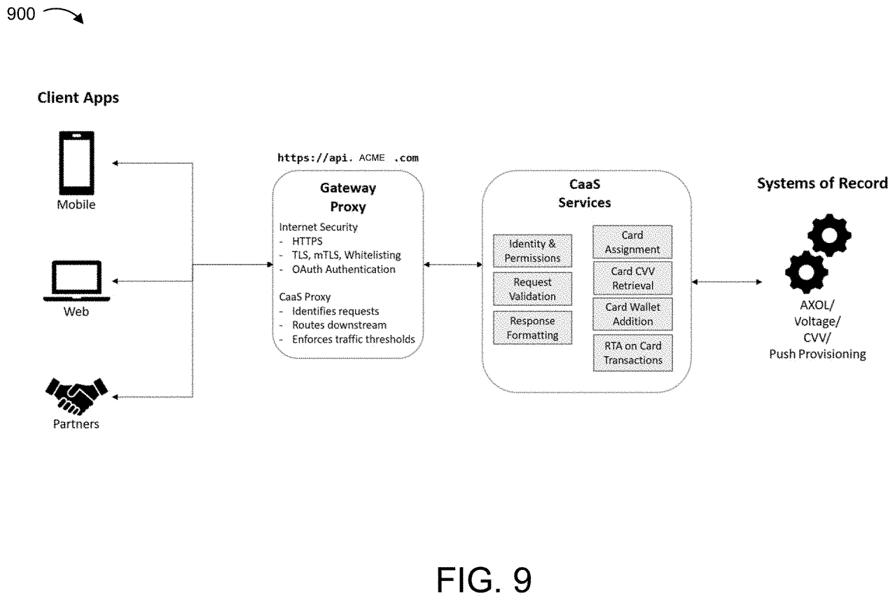

Referring now to FIG. 9, an illustration of a sequence 900 for generating and provisioning a virtual card is shown, in some embodiments. In sequence 900, a provisioning entity may access a card provisioning service via a gateway proxy. The provisioning entity may request a virtual card to the card provisioning service. The card provisioning service may generate and transmit a virtual card back to the requesting provisioning entity.

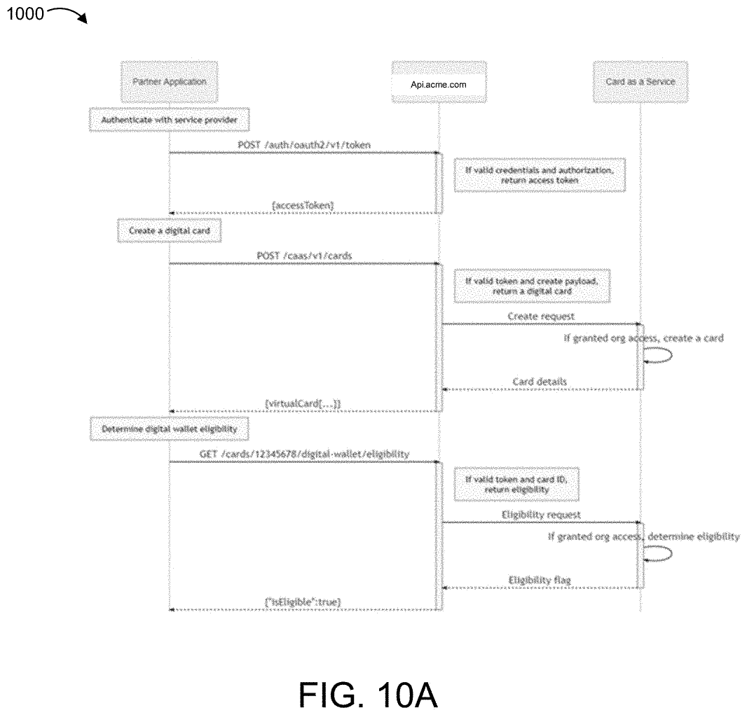

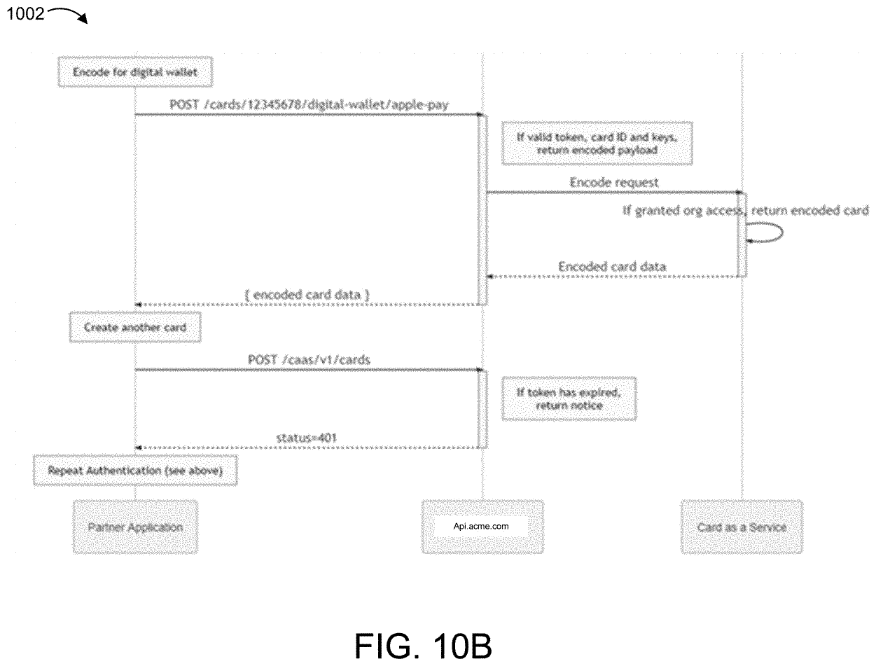

Referring now to FIG. 10A, an illustration of sequences 1000 for provisioning a virtual card and determining the virtual card's eligibility to be stored in a digital wallet is shown, in some embodiments. Sequences 1000 includes a sequence for authenticating a service provider (e.g., a provisioning entity), a sequence for creating a virtual card in response to a request from an application of the authenticated service provider, and a sequence for determining a wallet eligibility for the virtual card. In FIG. 10B, an illustration of sequences 1002 for encoding the virtual card into a digital wallet and for generating another virtual card is shown, in some embodiments. Sequences 1002 may include a sequence for encoding a virtual card such that the virtual card may be stored in a digital wallet, a sequence for attempting to generate another virtual card after the token for a provisioning entity has expired, and a sequence for re-authenticating the provisioning entity after the entities' authentication token has expired. The sequences depicted in FIGS. 10A and 10B are described in further detail below.

The embodiments described herein include virtual cards and wallets. A card can be issued and used independent of a digital wallet, or it can be securely added to a wallet for in-store, app, and online purchases. By way of example, the card has a Service URI basepath is of /caas/v1. The APIs are listed in the table below and detailed in the following sections. Note the API path below is appended to the basepath above, for example:

/caas/v1/cards/{cardID}/cvv

| API | Description | Result |
|---|---|---|
| POST/cards | Assign a new virtual card | Card details |
| | | and unique |
| | | cardID |
| GET/cards/{cardID}/cvv | Read the CVV code of a | CVV |
| | card | |
| POST/cards/{cardID}/close | Close a card with charges | Closed status |
| POST/cards/{cardID}/ | Cancel a card without | Canceled |
| cancel | charges | status |
| POST/cards/{cardID}/ | Determine if the card is | True/False |
| digital-wallet/eligibility | eligible for use with | |
| | digital wallets | |
| POST/cards/{cardID}/ | Prepare Apple Pay payload | Encoded card |
| digital-wallet/apple-pay | | payload |
| POST/cards/{cardID}/ | Prepare Google Pay | Encoded card |
| digital-wallet/google-pay | payload | payload |

API Conventions apply to each API and are explained below:
Authorization
Correlation ID
Organization Short Name
Error Response

### Authorization

Every request contains an access token to determine if the requestor is authorized to use the API. The Authorization header contains a ‘bearer token’ issued by the OAuth API, as explained in the Security Guide.

Authorization: Bearer fWxQY7PsJhyAAuo98Aj34YVV2vnFq

### Correlation ID

The Correlation ID is used to correlate a request with its response. The value in the request is echoed in the response by the API service. This is useful when performing end-to-end tracking of a request and its response during troubleshooting.

This value is logged by the service, but not validated. To differentiate one request from another, this ID should change each time a request is sent, including each retry of a failed request. Often, a GUID is used, but any unique string value is valid.

Correlation-ID: 123e4567-e89b-12d3-a456-42766544abcd

### Organization Short Name

Every request requires an organization short name (OSN) to identify in which organization the request will be fulfilled. The OSN will be provided during the implementation process and is specified in the Org-Short-Name′ header.

### Org-Short-Name: MyOrg

### Error Responses

Errors originate from the gateway or the API service. Consequently, gateway errors adhere to one response format, while service errors follow another. Please be aware of these two formats as described in the API specification.

The following sections describe the virtual card lifecycle and available API capabilities:
Create a virtual card
Read the CVV
Close or Cancel a card
Determine eligibility for adding a card to a digital wallet
Prepare a card payload for use with Apple Pay or Google Pay
   Virtual card Lifecycle

Initially, the create operation assigns a card for use as a payment. One or more authorized charges can be applied to the card balance. The close operation prohibits further charges. As described herein, a card balance may be an “available credit to spend.” When a virtual card is first provisioned, there may be a credit limit assigned to the card. The credit limit may be the maximum sum of all transactions that can be spent using the virtual card in a given time period. The “balance” may decline with each transaction against the virtual card. The cancel operation can be used to unassign a card prior to processing any charges. On the effective until date, the card payment expires prohibiting further use.

Creating a Virtual card

A virtual card can be issued to anyone and delivered via your application. This minimal information is necessary to create a card:

| Fieldname | Description |
|---|---|
| paymentAccountID | Payment account to fund the card |
| amount | Maximum purchase limit |
| effectiveUntil | On this date, the virtual card will expire and prohibit |
| | further use, as shown above in the lifecycle diagram. |
| | NOTE: This date is not the MM/YY card expiration |
| | date. |

User-specified attributes can be useful for managing a payment and tagging it with external references. The fields below allow users to attach attributes to the payment, which is available later when viewing or retrieving the payment.

| Fieldname | Description |
|---|---|
| comments[ ] | Optional lines of comment |
| customAttributes[ ] | Optional list of <name:value> pairs. The provided |
| | name must match a name previously configured in |
| | the system. A limited number are included in the |
| | system-managed remittance. |

If successful, a virtual card is created with these essential attributes:
16-digit card number
MM/YY expiration date
CVV security code

### Duplicate Request Detection

An idempotency key is required in the request, so the service can detect unintentional duplicate requests resulting from retries. This assures the request is executed only once as intended. The key should not change when a retry is attempted due to a timeout or other intermittent error.

The value is often a GUID but can be any unique string value. If the request is successful, its key is cached temporarily, and the service will recognize a duplicate key within that period.

Idempotency-Key: MyApp-73cd71d2-e80b-7d73-a4b6-def83028d73e
NOTE: The idempotency value should be maintained separately from the correlation ID:
The correlation ID should change with every request, including retries
The idempotency key should change with every create request, excluding retries

The example below creates a card with a limit of $512.55:

```
POST /caas/v1/cards HTTP 1.1
Authorization: Bearer fWxQY7PsJhyAAuo98Aj34YVV2vnFq
Accept: application/json
Content-Type: application/json
Correlation-ID: 123e4567-e89b-12d3-a456-42766544abcd
Idempotency-Key: MyApp-73cd71d2-e80b-7d73-a4b6-def83028d73e
Org-Short-Name: MyOrg
{
  “amount”: 512.55,
  “cardInfo”: {
    “firstName”: “Card”,
    “lastName”: “Holder”
  },
  “effectiveUntil”: “2021-11-01”,
  “paymentAccountID”: “123456789012”,
  “returnCVV”: false
}
```

If successful, the card details are returned, including the 16-digit card number and MM/YY expiration date. In this example, the CVV code is not returned. The caller provides these details to the target cardholder.

```
HTTP/1.1 201 Created
Content-Type: application/json
Correlation-ID: 123e4567-e89b-12d3-a456-42766544abcd
Location: /caas/v1/cards/12345678
Version: 1.0.0
{
  “virtualCard”: {
    “ID”: “12345678”,
    “number”: “1111222233334444”,
    “expirationDate”: “2022-04-30”
  }
}
```

### (1) Reading the CVV

Given a card ID, the CVV can be returned. This is useful when the CVV was not returned when the card was created.

GET /caas/v1/cards/4313678925/cvv HTTP 1.1
Authorization: Bearer fWxQY7PsJhyAAuo98Aj34YVV2vnFq
Accept: application/json
Correlation-ID: e3214567-e89b-12d3-a456-42766544dcba
Org-Short-Name: MyOrg
If successful, the CVV is returned.
HTTP/1.1 200 OK
Content-Type: application/json
Correlation-ID: e3214567-e89b-12d3-a456-42766544dcba
Version: 1.0.0
{
“CVV”: “123”
}

### (2) Closing or Canceling a Card

Given a card ID, the virtual card payment can be closed or canceled. A card may be:
Closed when charges exist, to prohibit additional charges
Canceled prior to processing any charges
   At the effectUntil date, the card will expire which prohibits further use.

POST /caas/v1/cards/12345678/close HTTP 1.1
Authorization: Bearer fWxQY7PsJhyAAuo98Aj34YVV2vnFq
Accept: application/json
Correlation-ID: e3214567-abcd-4321-a456-42766544aaaa
Org-Short-Name: MyOrg
A successful response consists of only the 204 status code:
HTTP/1.1 204 No Content
Correlation-ID: e3214567-abcd-4321-a456-42766544aaaa
Version: 1.0.0
Digital Wallet

‘Digital Wallet’ refers to the wallet application on a smartphone and is specific to the mobile operating system on the device. CaaS provides support for digital wallets:
Determine if a virtual card is eligible for use with a digital wallet
Encode the card details for a specific wallet provider

### Eligibility

Given a card ID, eligibility for use with digital wallets is confirmed by the card network. This is useful to determine if the “Add to Wallet” icon can be displayed.

### Apple-Pay and Google-Pay

Given an eligible card and necessary keys, the card attributes are encoded into a format prescribed by the wallet provider, either Apple-Pay or Google-Pay, and returned. Subsequently, the returned payload is used by the caller to submit the card for adding to the wallet on a specific device.

The inputs to this wallet API are obtained from the wallet provider SDK, not from CaaS. The encoded outputs are a collaboration between CaaS services, the wallet provider, and the card network.

### Workflow

The sequence diagram below is a sample sequence of CaaS API requests (and is not exhaustive). The workflow includes these significant steps:
1. OAuth API is used to obtain a temporary access token
2. The access token is used to create a virtual card, which returns a unique cardID
3. Using the access token and cardID, determine wallet eligibility for that card
4. Given keys and cardID, encode the card details in the prescribed wallet format
5. At any time, encountering a 401 status indicates the access token has expired
6. Use the OAuth API (step 1) to obtain another temporary token, and resume using CaaS APIs

The details of obtaining an access token are documented in the Security Guide. The access token must be included in all API requests within the Authorization header. In the examples above, this is the access token header:

Authorization: Bearer fWxQY7PsJhyAAuo98Aj34YVV2vnFq

When access has expired, the 401 status is returned. To regain access, repeat OAuth authentication to acquire another token.

### HTTP/1.1 401 Unauthorized

{
. . . error message . . .
}

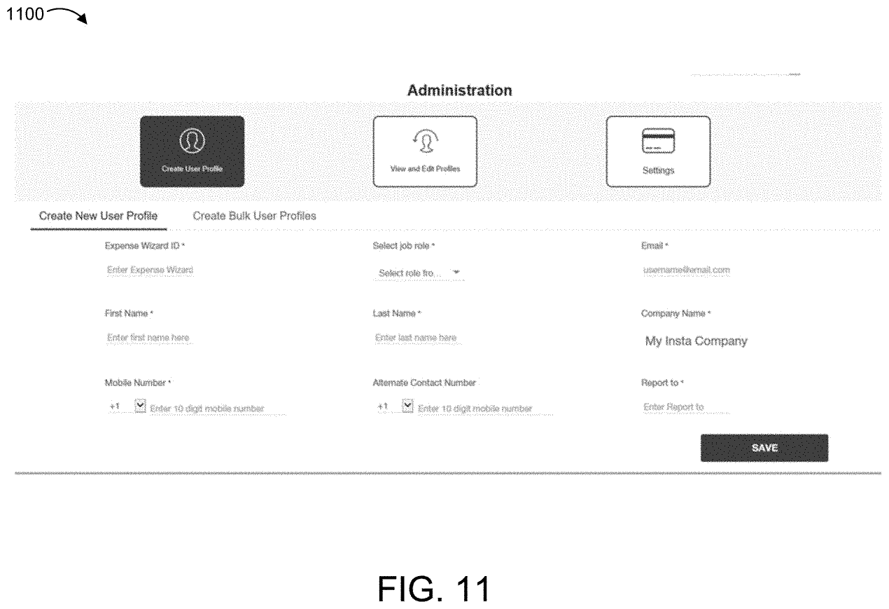

Referring now to FIG. 11, an illustration of a user interface 1100 for creating a user profile for provisioning virtual cards is shown, in some embodiments. User interface 1100 includes multiple fields that a user may fill out to create a user profile for a user that can access a virtual card generation and provisioning system (e.g., virtual card generator 104). The individuals that correspond to the user profiles may be “provisioners” that can access the system to request virtual cards from the system to provision to other individuals. As illustrated, user interface 1100 may enable administrators to create individual user profiles or user profiles for multiple individuals.

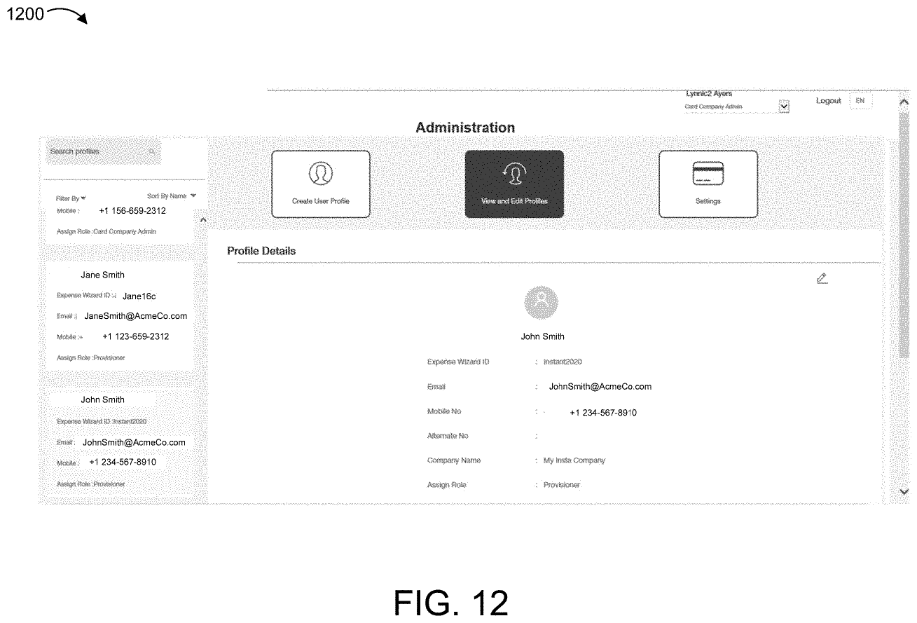

Referring now to FIG. 12, an illustration of a user interface 1200 including a provisioner's profile is shown, in some embodiments. User interface 1200 may depict information about an individual that is stored in the profile and enable the information to be edited such as to correct or remove such information. As illustrated, the data may include the role of the profile that indicates the different permissions the profile has. An example of a role may be a provisioner, described above. Another example of a role may be an “approver,” which may be an individual that can view the requests from provisioners and either approve or disapprove of the requests. The approver can view data about requests for virtual cards, including any use parameters for the virtual cards, and send signals to the system to stop or allow virtual cards to be provisioned. In some embodiments, the system may not generate or provision virtual cards back to a provisioning entity until after the approver approves of the virtual cards. As described herein, a reference to a provisioner or an approver may be a reference to the provisioner or approver as an individual or as a computing device that such an individual is accessing.

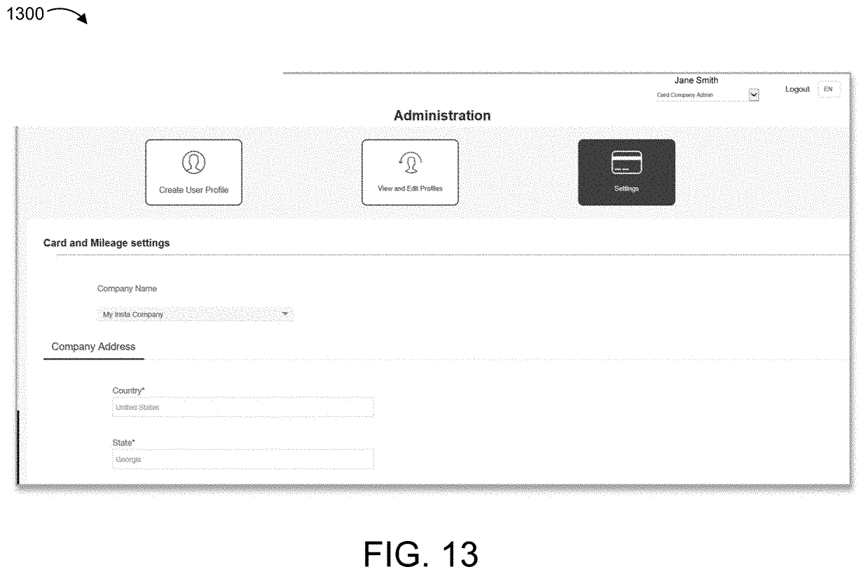

Referring now to FIG. 13, an illustration of a user interface 1300 including settings for a provisioning entity is shown, in some embodiments. An administrator may access the settings to change information about the provisioning entity to ensure the information is accurate and complete.

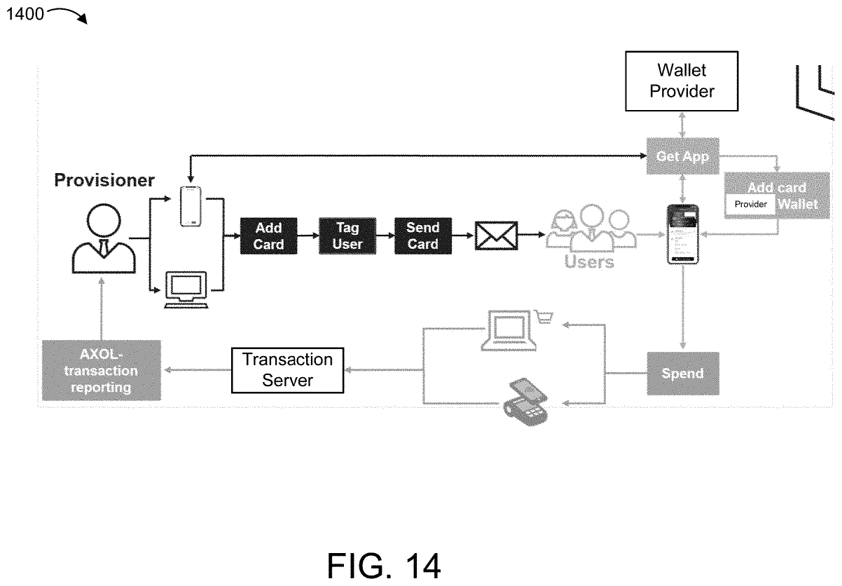

Referring now to FIG. 14, an illustration of a sequence 1400 for provisioning a virtual card to a computing device and storing the virtual card in a digital wallet of the computing device is shown, in some embodiments. In sequence 1400, a user with a provisioner role may access a virtual card generation and provisioning system (e.g., virtual card generator 104) and request one or more cards to provision to users. The provisioner may receive the virtual cards from the virtual card generation and provisioning system, in some cases after an approver approves the request for the virtual cards. The provisioner may then send the requested virtual cards to computing devices of the users for which the provisioner requested virtual cards. The devices may receive and store the virtual cards in digital wallets stored in memory of the computing devices. The users may then use the virtual cards to make purchases, which may cause the entities on the other side of the transaction to transmit the virtual card data to a transaction server (e.g., a server of a bank) to facilitate the transaction. The transaction server may store the profiles that correspond to the virtual cards, thus enabling the transaction server to either enable or restrict the transactions from occurring. For each transaction, the transaction server may send an indication of the transaction back to the provisioner's device with data for the transaction to inform the provisioners of any transactions that occurred using the provisioned virtual cards.

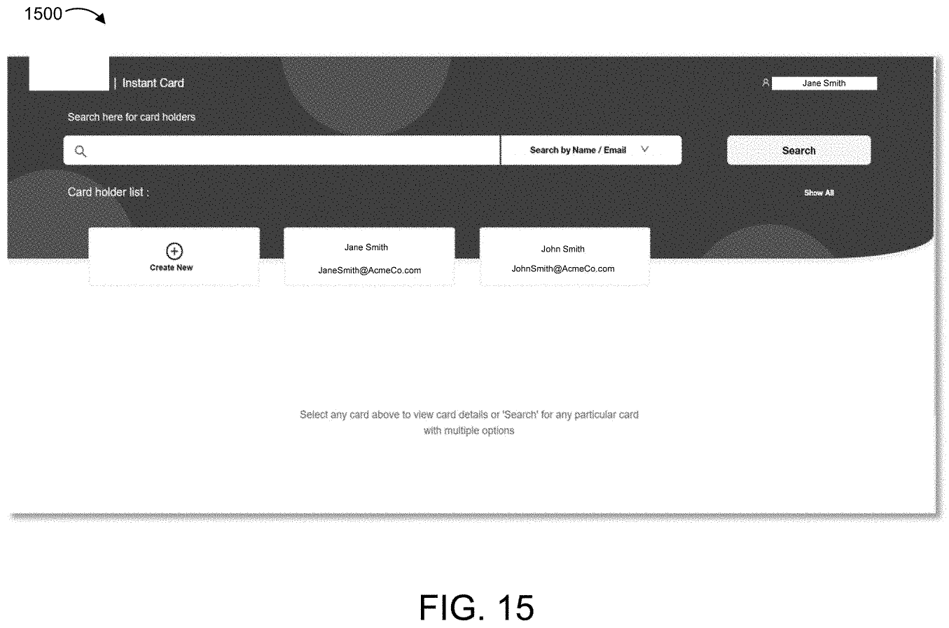

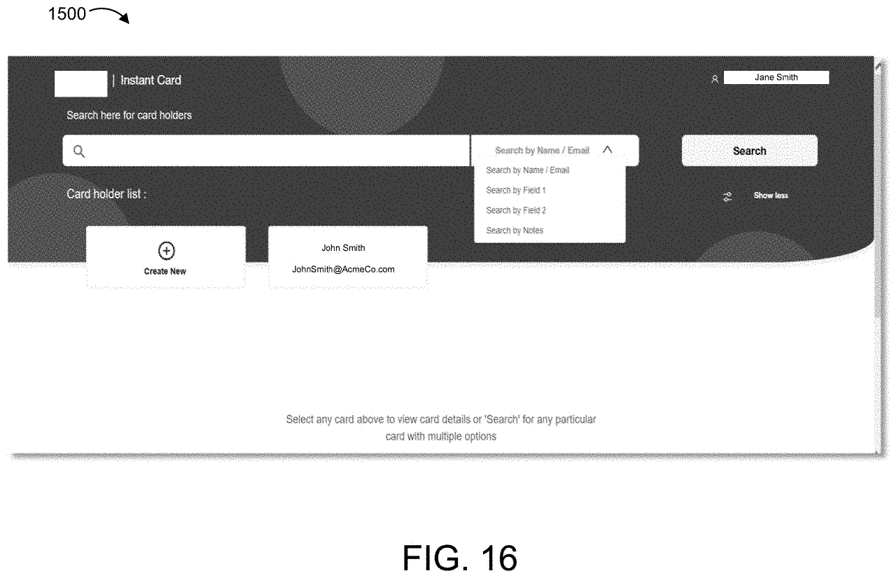

Referring now to FIG. 15, an illustration of a user interface 1500 for searching users that have virtual cards is shown, in some embodiments. User interface 1500 may include a list of profiles for which a virtual card has been provisioned and a form that enables administrators to search for the profiles of different cardholders using different criteria. FIG. 16 illustrates user interface 1500 with a dropdown that enables users to filter the search for different cardholders based on the different criteria (e.g., name, email, fields, notes, etc.).

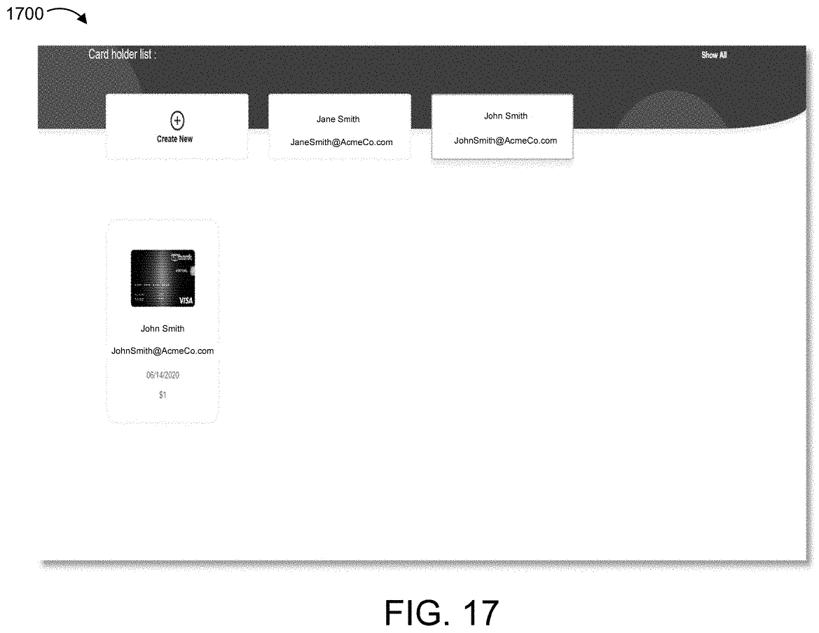

Referring now to FIG. 17, an illustration of a user interface 1700 that shows information for a virtual card cardholder, in some embodiments. User interface 1700 may be displayed after a user inputs a search criteria into user interface 1500, shown and described with reference to FIGS. 15 and 16. As illustrated, upon searching for cardholders, a list of cardholders may appear with specific information about the cardholders (e.g., email, expiration date, spending limit, etc.). The list may include any number of cardholders and any amount of data about the cardholders.

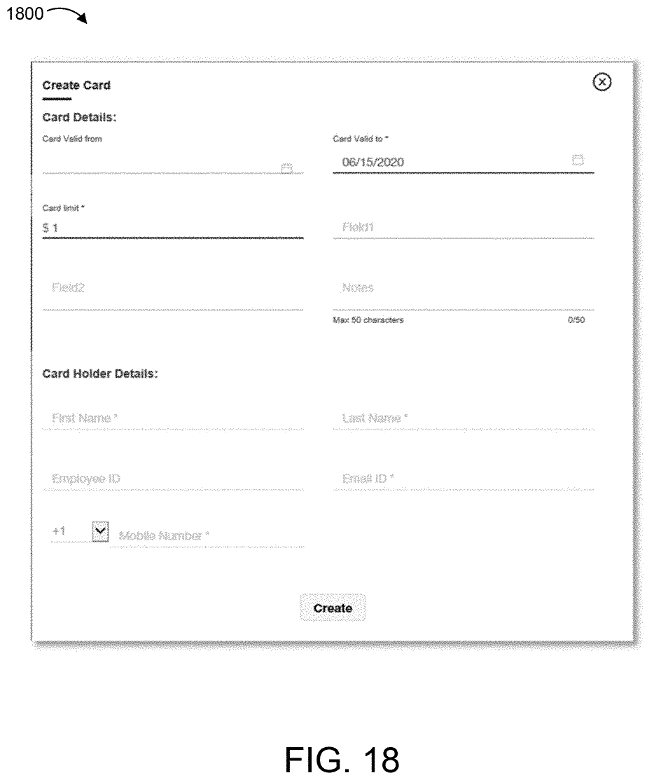

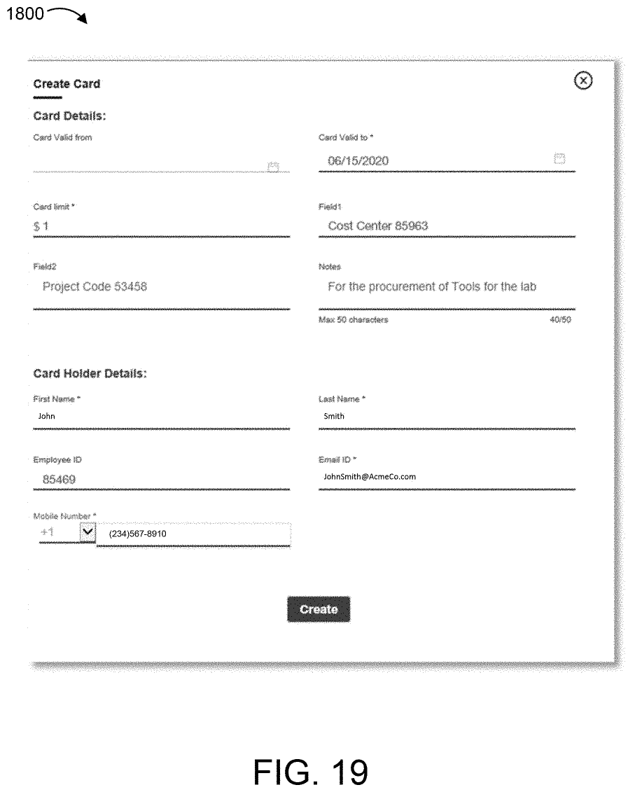

Referring now to FIG. 18, an illustration of a user interface 1800 that can be used to generate a virtual card is shown, in some embodiments. A user profile with a provisioner role may access user interface 1800 to make a request for a virtual card. A user may input information about the individual that will receive the virtual card in the fields of user interface 1800. In some embodiments, the user may also input different use criteria indicating when, where, and/or how the virtual card can be used to make purchases. The information may be received from user interface 1800 by a virtual card generation and provisioning system (e.g., virtual card generator 104) and used to create a data packet for a virtual card. As described herein, the virtual card generation and provisioning system may provision such a data packet to a computing device of the recipient so the recipient can use the data packet to make purchases. FIG. 19 shows user interface 1800 with example data included in the fields of user interface 1800.

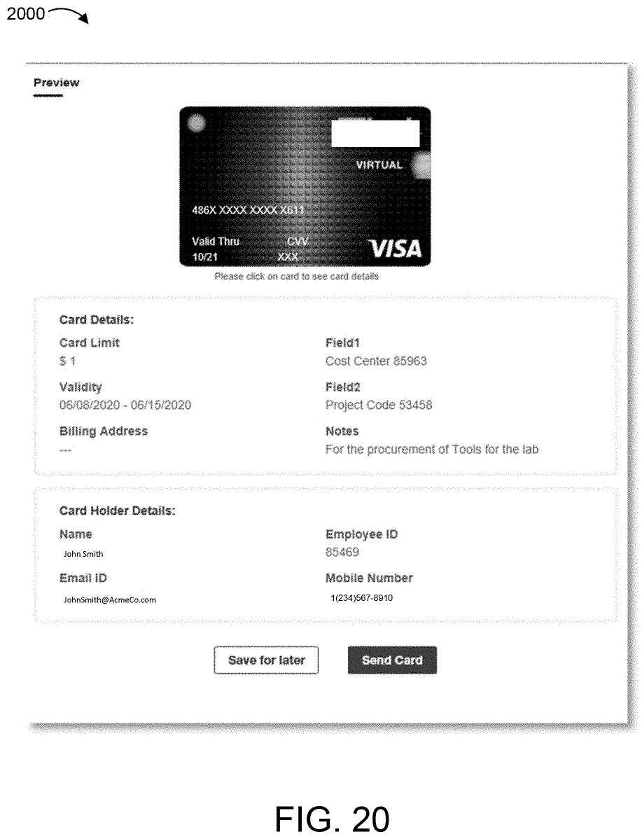

Referring now to FIG. 20, an illustration of a user interface 2000 that contains a preview of a virtual card that has been generated is shown, in some embodiments. User interface 2000 may be generated after a user selects a “create” button on user interface 1800, shown and described with reference to FIGS. 18 and 19. User interface 2000 contains an image of the virtual card itself, details about the card, and details about the recipient of the card. A provisioner may view the details and either save the details to be viewed and/or to be sent at a later time or select a send card button to send the data packet for the virtual card to the recipient's computing device.

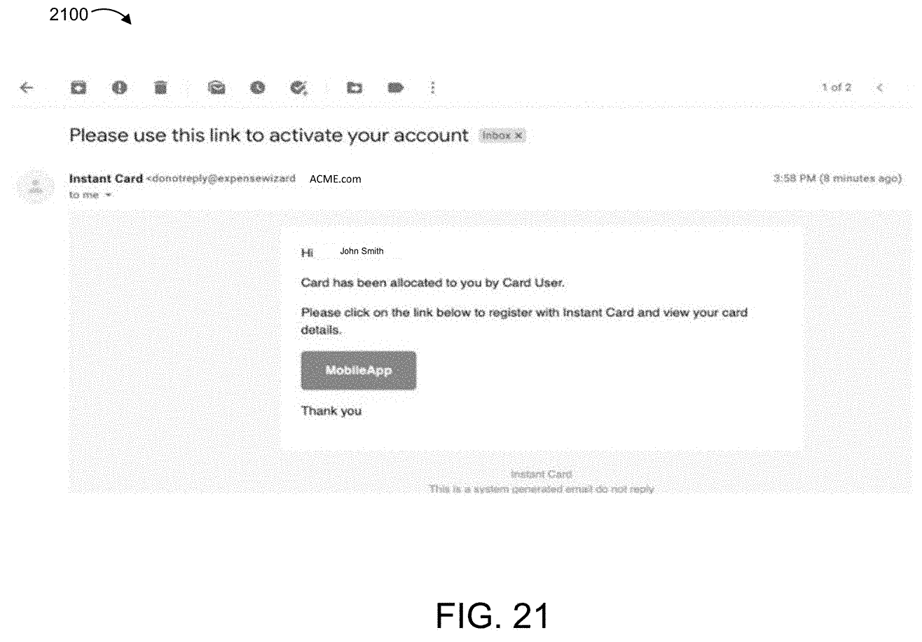

Referring now to FIG. 21, an illustration of a user interface 2100 that includes an example email notification that has been sent to a recipient of a virtual card is shown, in some embodiments. User interface 2100 may illustrate an email that was sent as a result of a user sending the data packet for the virtual card of user interface 2000, shown and described with reference to FIG. 20. As illustrated, the recipient may view the email and select a mobile application button to register with an application that is capable of receiving virtual cards and/or to view details about the virtual card. Other examples of notifications that may be sent to users include, but are not limited to, texts and push notifications that may be sent to users' mobile devices. Such notifications may be similar and involve a similar process to the email notification of user interface 2100. Any

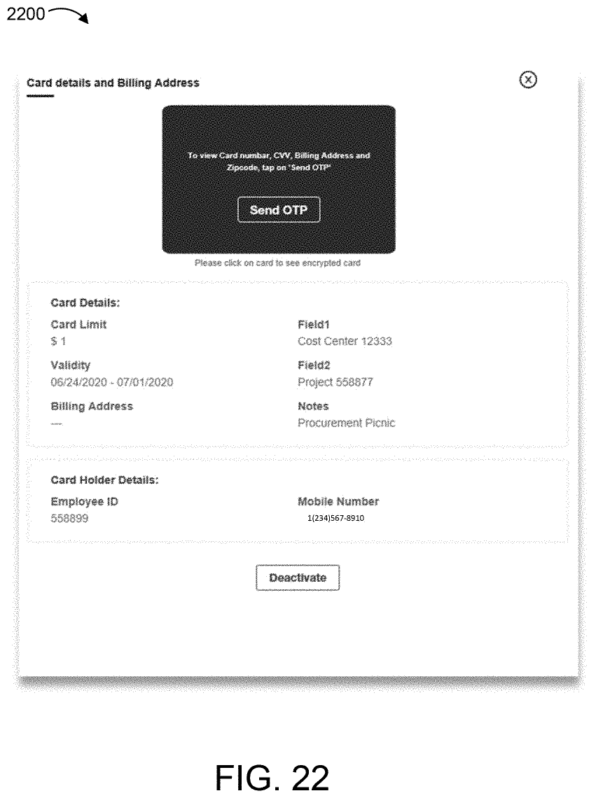

Referring now to FIG. 22, an illustration of a user interface 2200 containing information about a provisioned virtual card is shown, in some embodiments. A provisioner may access and view user interface 220 to view information about a provisioned virtual card and/or deactivate the virtual card so it cannot be used. For example, a provisioner may select a deactivate button from user interface 2200 that will change a setting in the profile that corresponds to the virtual card to indicate to restrict or stop any transactions that are performed using the virtual card. In some embodiments, when the provisioner selects the deactivate button, a virtual card generation and provisioning system (e.g., virtual card generator 104) may transmit a signal to the mobile device that stores the virtual card to remove the virtual card from memory, make the virtual card inaccessible, and/or to otherwise update a setting on the device so the virtual card cannot be used for purchases. In some embodiments, user interface 2200 may include forms that enable a user to edit the virtual card such as to change the credit limit or the expiration date on the card. The user may also edit the card to change its use criteria to add or remove restrictions and when, where, and/or how the card may be used. In some embodiments, user interface 2200 may include a real-time view of authorization messages, a view of a transaction history, and a real-time view of the available credit that is left to spend on each card.

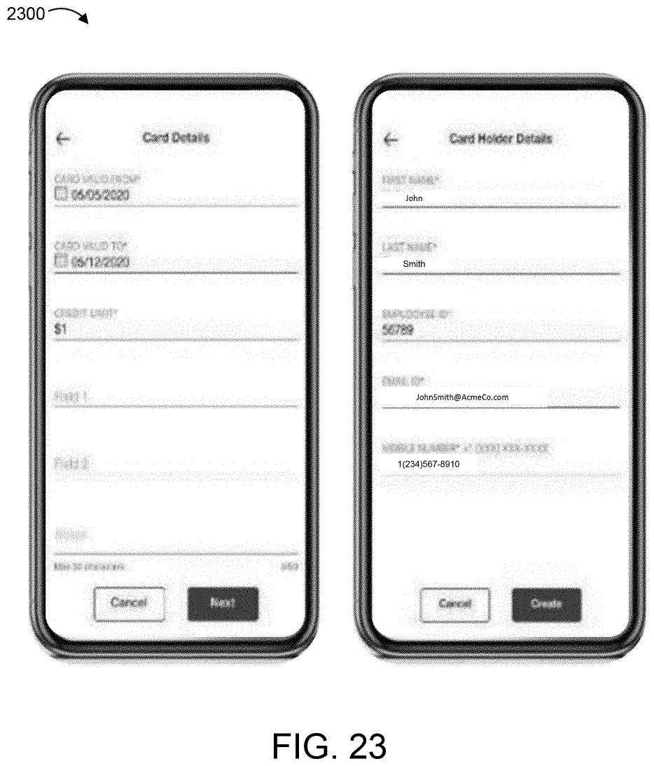

Referring now to FIG. 23, an illustration of a user interface 2300 on a mobile device that enables a provisioner to generate and provision a virtual card to a user is shown, in some embodiments. User interface 2300 is similar to user interface 1800, shown and described with reference to FIGS. 18 and 19, but as the user interface would appear on a mobile device. A provisioner may view and input information user interface 2300 to request a virtual card to be created that can then be provisioned to a recipient computing device.

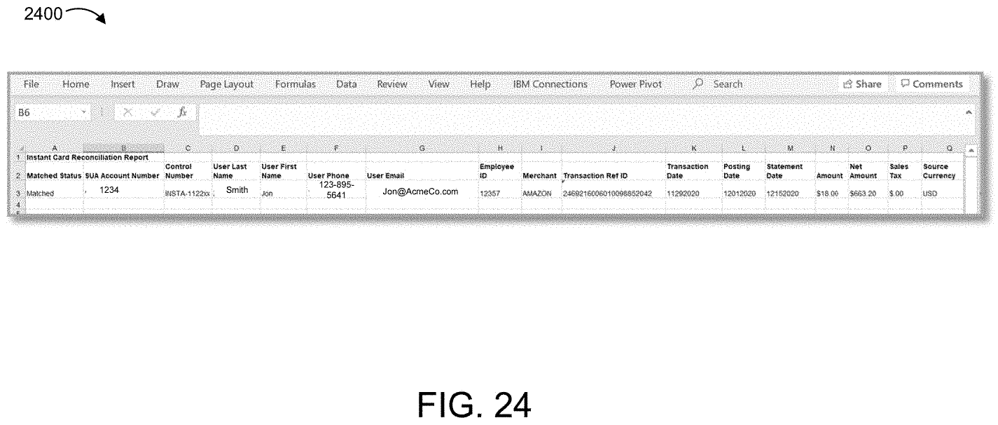

Referring now to FIG. 24, an illustration of an example virtual card reconciliation report 2400 is shown, in some embodiments. Reconciliation report 2400 may be used to reconcile any purchases that are made using a virtual card to make sure the information about the transaction is accurate and the profile associated with the virtual card is accurate and up-to-date (e.g., the available credit of the account is accurate and up-to-date).

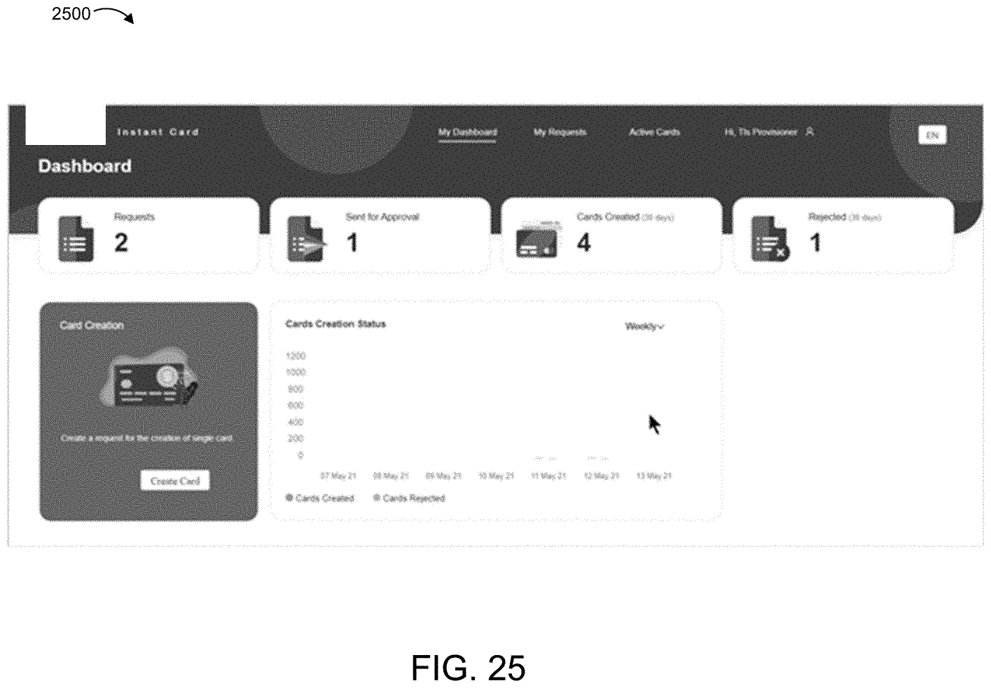

Referring now to FIG. 25, an illustration of a user interface 2500 containing a virtual card provisioning dashboard that contains information about virtual cards that have been generated and provisioned is shown, in some embodiments. The virtual card provisioning dashboard may include statistics about the number of virtual cards a provisioner or provisioning entity has requested, a number of virtual cards that have been sent for approval, a number of virtual cards that have been created as a result of the requests, a number of virtual cards that have been created and/or approved, and a number of virtual cards that have been rejected. The dashboard may also enable a user to access a user interface to create and/or request a virtual card (e.g., user interface 1800) and to view statistics about the virtual cards that have been requested and/or created in various time periods (e.g., weekly, monthly, annually, etc.). In some embodiments, although not shown, the virtual card provisioning dashboard may include information on the number of virtual cards that were individually created and that were created as a result of bulk requests.

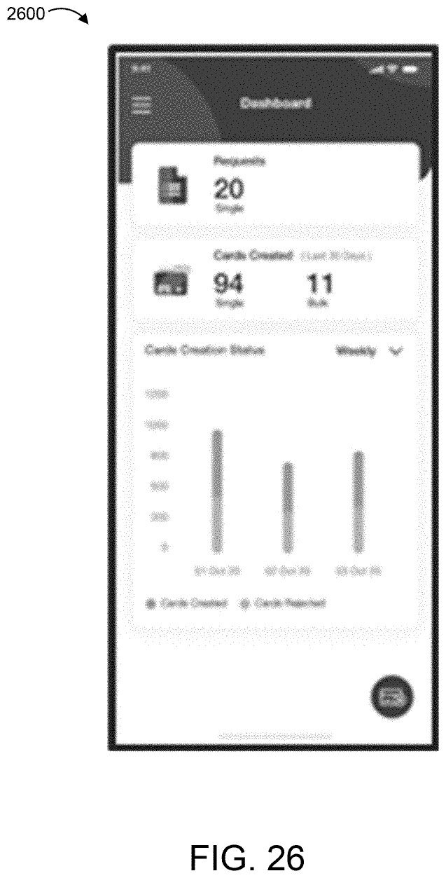

Referring now to FIG. 26, an illustration of a user interface 2600 of a virtual card provisioning dashboard similar to user interface 2500, shown and described with reference to FIG. 25, but on a mobile device interface. The virtual card provisioning dashboard on the mobile device may include the same or similar information and/or features as user interface 2500.

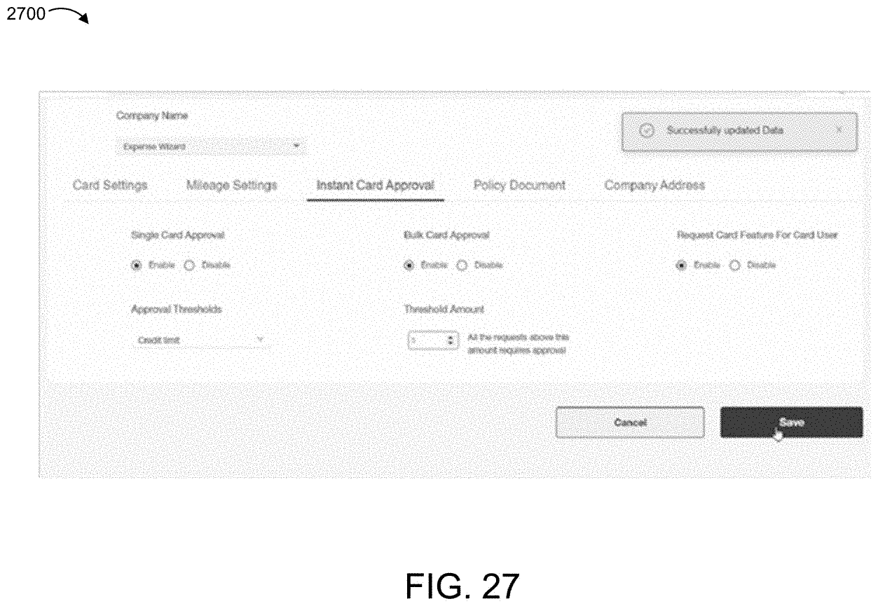

Referring now to FIG. 27, an illustration of a user interface 2700 containing virtual card provisioning policy settings for a provisioning entity is shown, in some embodiments. An administrator of a virtual card generation and provisioning system (e.g., virtual card generator 104) may access user interface 2700 and set settings indicating the privileges and/or permissions a provisioning entity may have when requesting virtual cards. Via such settings, a provisioning entity may be limited as to whether it can request single virtual cards, cards in bulk requests, enable individual users of the provisioning entity to request cards, and set approval thresholds such as credit limit. In some embodiments, the provisioning entity may use the setting to limit the number of requests that can be made before the requests require approval.

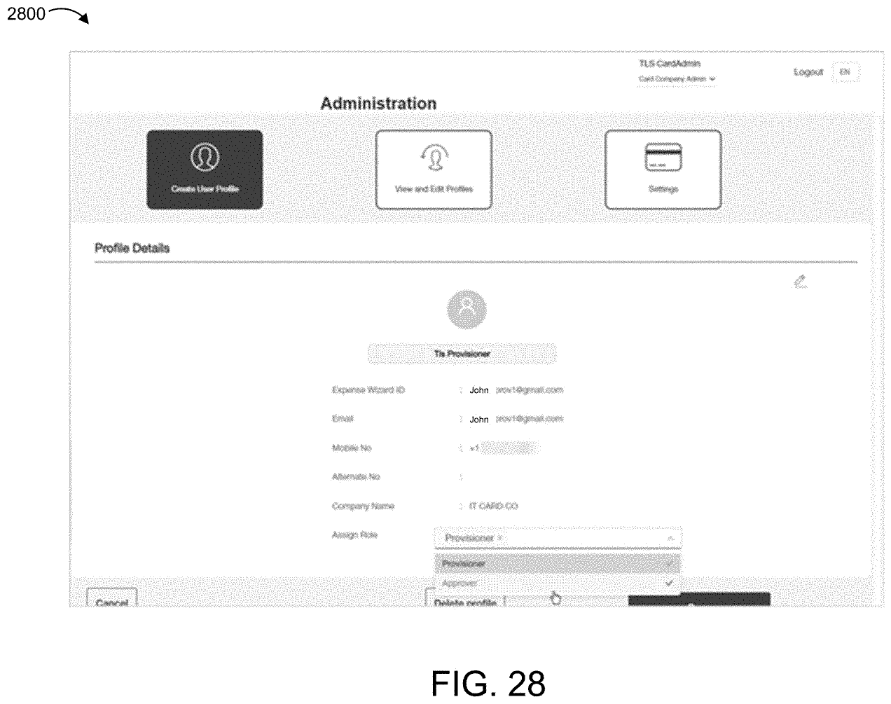

Referring now to FIG. 28, an illustration of a user interface 2800 for assigning a role to a profile is shown, in some embodiments. User interface 2800 may include information about an individual profile of a provisioning entity and the ability to change or update the profile's role to be a provisioner, an approver, both roles, or neither role.

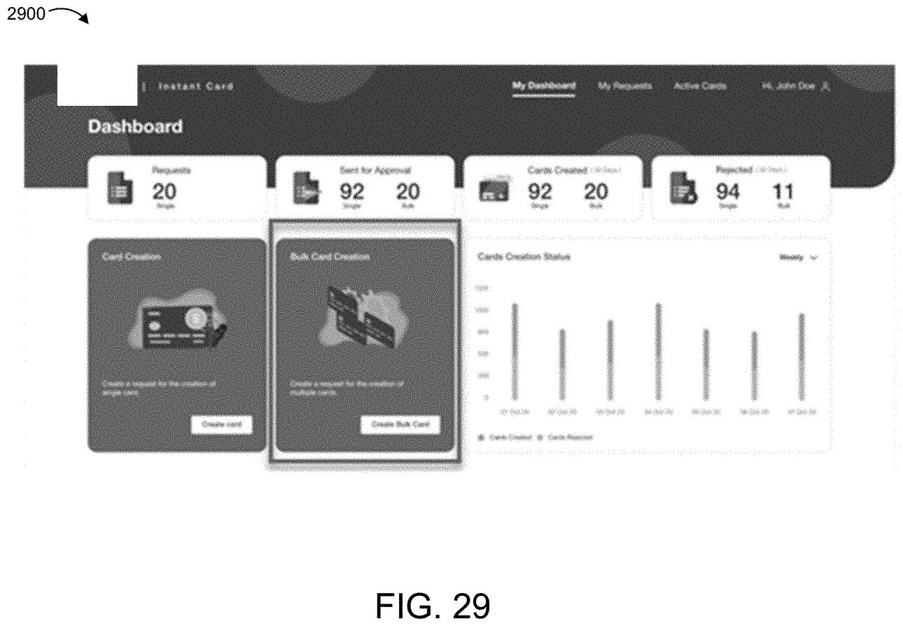

Referring now to FIG. 29, an illustration of a user interface 2900 containing a virtual card provisioning dashboard with bulk virtual card generation enabled is shown, in some embodiments. The virtual card provisioning dashboard of user interface 2900 may enable a user to request virtual cards in bulk and view information about such requests.

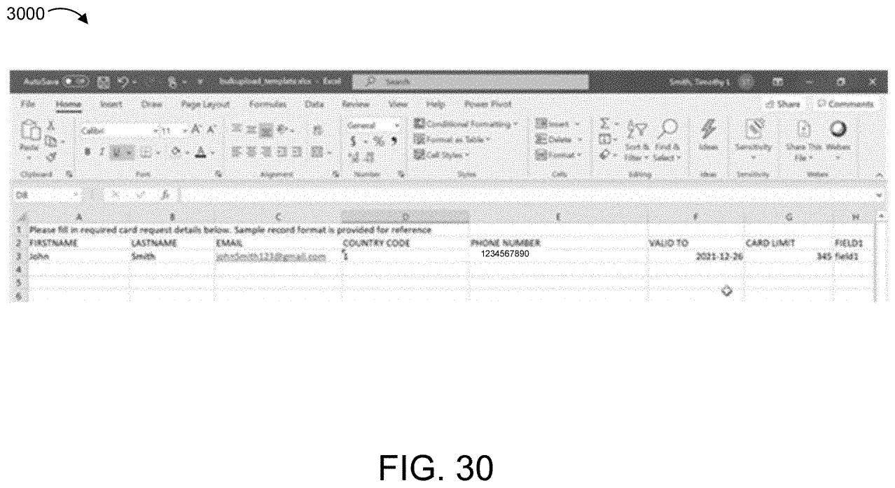

Referring now to FIG. 30, an illustration of a bulk upload file 3000 is shown, in some embodiments. Bulk upload file 3000 may be or contain a spreadsheet. The file 3000 could be or contain other structures, including a blockchain. A user may create such a spreadsheet for a bulk request with information for multiple virtual cards. In the spreadsheet, each row may include information for a different virtual card, with each cell including data for a specific type of data (e.g., first name, last name, email, country code, phone number, valid date, card limit, use parameters, etc.). A provisioner may create such a spreadsheet and upload the spreadsheet to request multiple virtual cards in one request to a virtual card generation and provisioning system (e.g., virtual card generator 104). The system may receive such a request, generate a virtual card data packet for each row of the spreadsheet, and transmit the data packets back to the provisioner to provision to the individuals identified in the rows of the spreadsheet.

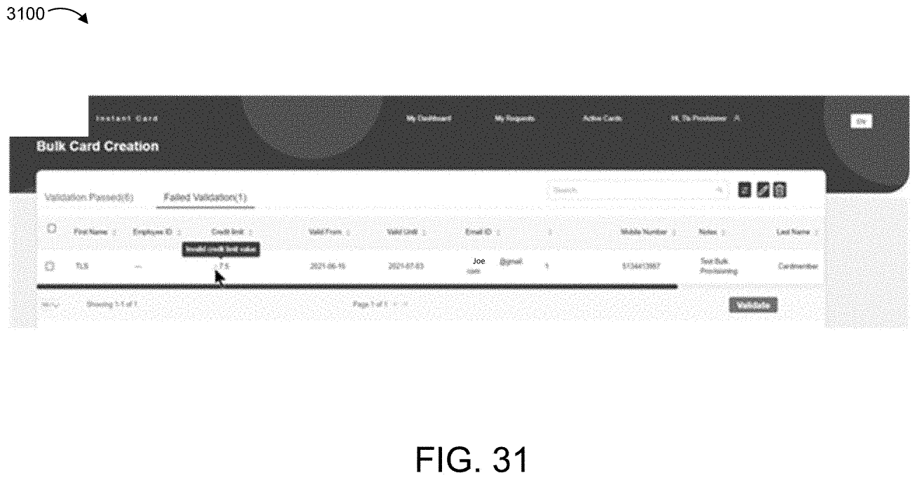

Referring now to FIG. 31, an illustration of a user interface 3100 containing a list of failed virtual card validations that resulted from a bulk virtual card generation request, in some embodiments. User interface 3100 may include a list of virtual cards that could not be validated from a bulk request for virtual cards. This may occur if an approver provides an input restricting specific virtual cards from being generated. The list may include information about the requested virtual card including an indication of why the card could not be created. In one example, as illustrated in user interface 3100, an indication may be placed in a column associated with a specific attribute that indicates the value for the attribute that caused validation for the virtual card to fail. A user may hover an indicator over the attribute to view why the value caused validation to fail.

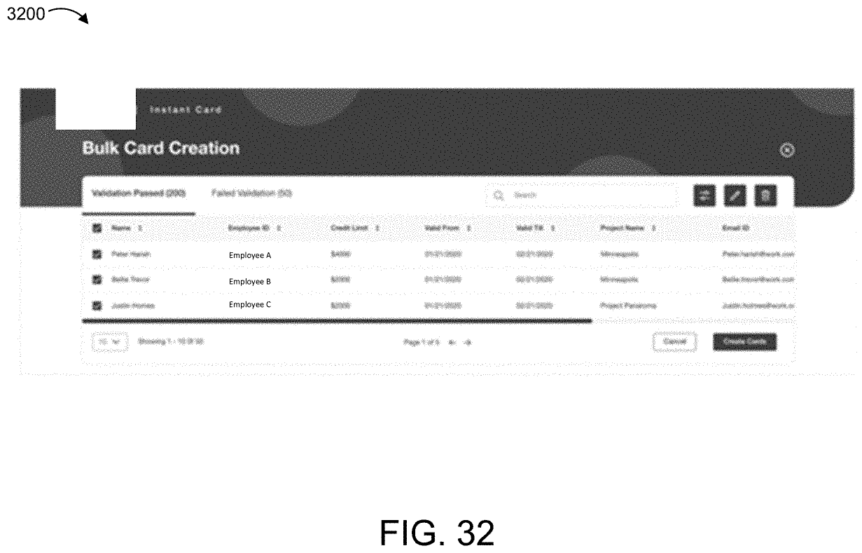

Referring now to FIG. 32, an illustration of a user interface 3200 containing accepted virtual card validations that resulted from a bulk virtual card generation request is shown, in some embodiments. User interface 3200 may include a list of virtual cards that were successfully validated based on the data and parameters and that were included in a bulk card request.

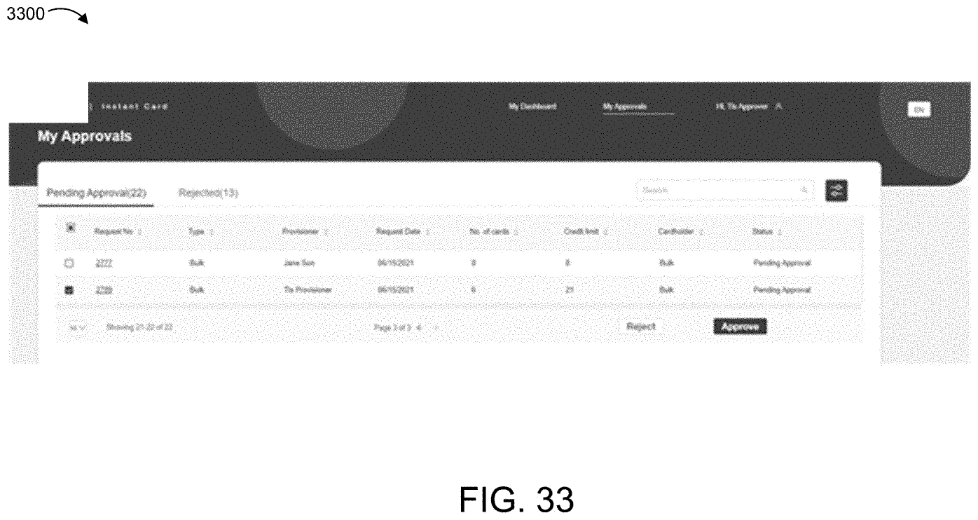

Referring now to FIG. 33, an illustration of a user interface 3300 containing the approval status of a list of bulk card requests is shown, in some embodiments. The list of user interface 3300 may include information about one or more bulk requests such as request number, the provisioners that made the requests, the number of virtual cards that were requested, the credit limits for each request, the cardholders of the request (which may be bulk or individually identify the intended recipient of a virtual card), and an approval status of the request.

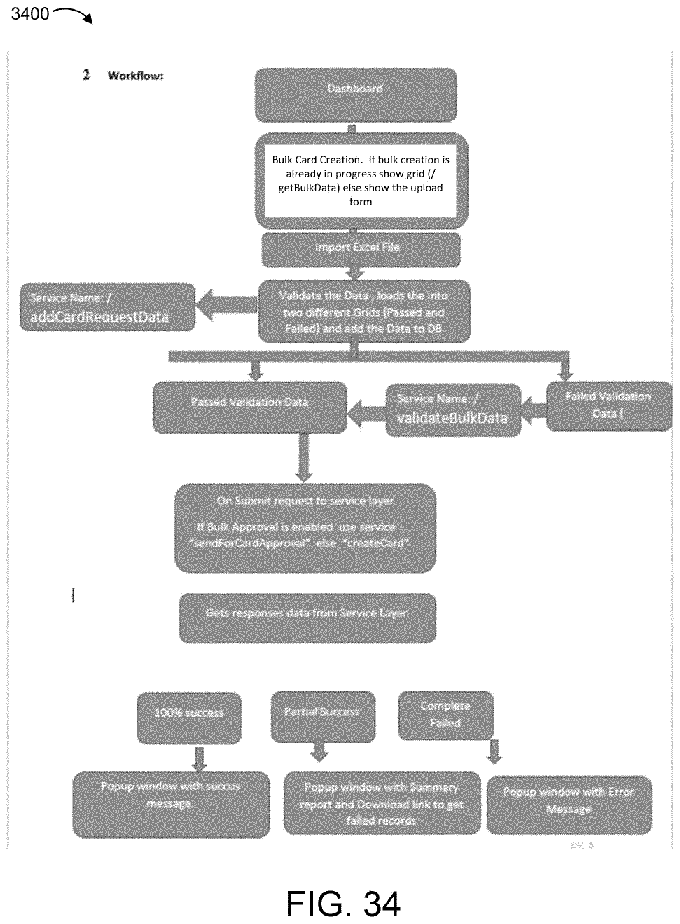

Referring now to FIG. 34, a flow diagram of a method 3400 for bulk virtual card generation is shown, in some embodiments. A system performing method 3400 may generate a user interface for a user with a provisioner role, receive a spreadsheet file from the provisioner that contains information for multiple virtual cards, validate the information for each virtual card to ensure the virtual card is in accordance with policy, generate the validated virtual cards that meet the policy, and transmit the virtual cards back to the provisioner.

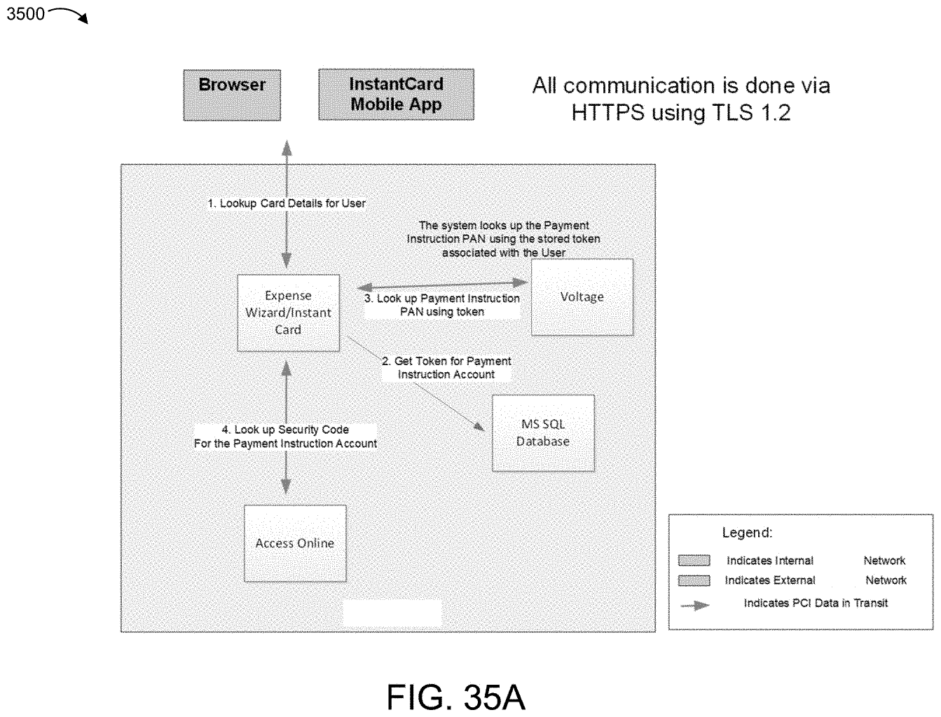

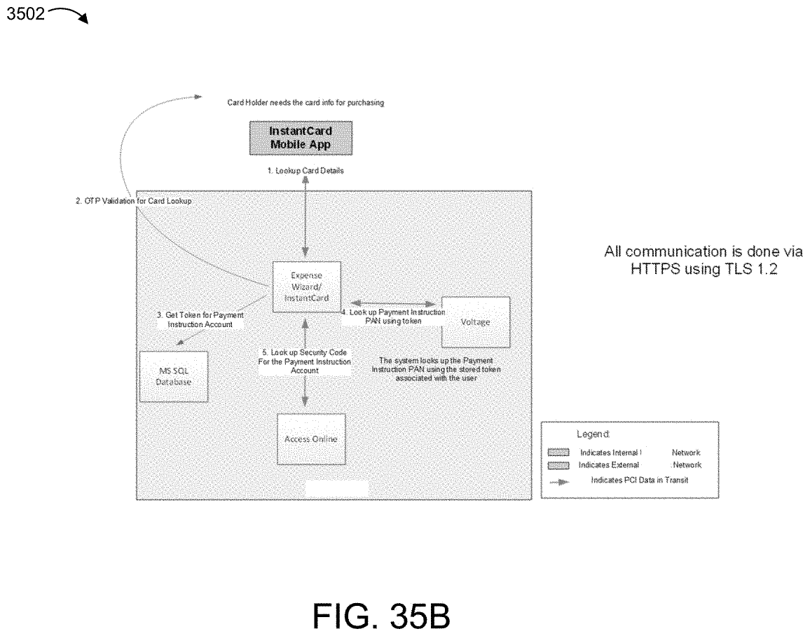

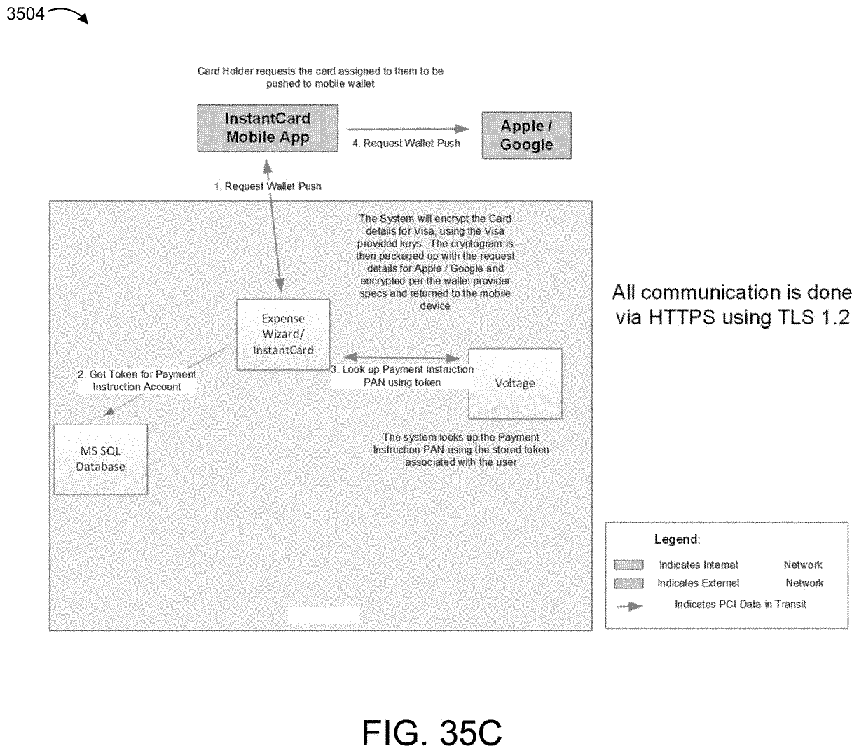

Referring now to FIG. 35A, a sequence diagram of a sequence 3500 for making a payment using a virtual card is shown, in some embodiments. Sequence 3500 may include a computing device that receives a transaction request including information (e.g., a virtual card identifier) for the virtual card, retrieves a token that corresponds to the virtual card from a database, uses the token to access an account for the virtual card, and retrieves a security code for the virtual card. After retrieving this information, the system may determine if the transaction is in accordance with any use parameters associated with the virtual card and, if the use parameters are satisfied, facilitate the transaction.

Referring now to FIG. 35B, a sequence diagram of a sequence 3502 for making a payment using a virtual card, in some embodiments. Sequence 3502 may include similar steps to sequence 3500, but include an additional identity verification step to verify the identity of the user that is attempting to use the virtual card to make a payment. Such verification may be a one-time passcode or other verification such as two-factor authentication.

Referring now to FIG. 35C, a sequence diagram of a sequence 3504 for making a payment using a virtual card, in some embodiments. Sequence 3504 may include similar steps to sequence 3500, but instead of retrieving the security code for the virtual card, a mobile application that is using a virtual card to make a purchase may send a message to a digital wallet containing the virtual card to verify the virtual card can be used to make a purchase.

### Bulk Virtual Card Generation System

As previously mentioned, a computer may be configured to receive requests to generate individual virtual cards and/or virtual cards in bulk. When receiving a request to generate an individual virtual card, the request may include use restrictions for the virtual card and/or a maximum transaction value (e.g., a maximum transaction value for a single transaction or a transaction value limit for multiple transactions) for the virtual card. The computer may receive the request with the use restrictions and/or the maximum transaction value and generate an account (e.g., a profile or a virtual card account) according to the use restrictions and maximum transaction value and provision a virtual card for the account to the requesting computing device. In some cases, the computer may generate a virtual card according to preset use parameters and/or a maximum transaction value.

In some cases, the computer may receive a request for multiple virtual cards (e.g., a bulk request). The request may include identifiers for entities for which the virtual cards are being generated without any use restrictions and/or maximum transaction values. The request may exclude such use restrictions and/or maximum transaction values because the computing device transmitting the request may not have access to use restrictions and/or to lower the size of the request to lower the bandwidth requirements of transmitting the request. The bandwidth requirements may be large when requesting virtual cards for a large number of entities with different permutations of use restrictions. Because the request only includes identifiers of the entities, the computer receiving the request and provisioning the virtual cards may not have a way to differentiate between the different entities to determine which use restrictions to apply to which virtual cards, instead applying the same use restrictions and maximum transaction values to each virtual card.

A computer may implement the systems and methods described herein to overcome the aforementioned technical deficiencies and generate and provision virtual cards with differing use restrictions for different entities in response to receipt of a bulk request. To do so, for example, a remote computing device may include metadata regarding different entities and identifiers for the entities in a bulk request for virtual cards that the remote computing device transmits to the computer. The computer may receive the bulk request and parse the bulk request by dividing the identifiers in the request into sets of identifiers according to the metadata (e.g., group the identifiers into sets of identifiers that have common characteristics with each other). The computer may retrieve restriction policies containing use restrictions and/or maximum transaction values from memory that each correspond to a different set of identifiers. The computer may then generate accounts according to the restriction policies by retrieving the use restrictions and/or the maximum transaction values from the restriction policies. The computer may insert the use restrictions and/or the maximum transaction values into data structures of the accounts in the sets of accounts that correspond to the restriction policies. The computer may then transmit a data packet or data packets containing virtual cards that correspond to the generated accounts to the requesting remote computing device. The remote computing device may transmit the virtual cards to electronic accounts (e.g., email addresses or phones numbers) of the entities associated with the identifiers in the bulk request. In this way, the computer may generate virtual cards and accounts that correspond to the virtual cards for a single bulk request with differing use restrictions between the virtual cards without receiving any use restrictions in the request.

In some cases, the computer implementing the systems and methods described herein can communicate with a remote computing device to generate virtual cards for entities in response to an event. For example, the remote computing device may be a computing device accessed or owned by an airline. The remote computing device may monitor the status of various flights performed by the airline. In doing so, the remote computing device may detect when a flight is delayed or canceled and/or whether the delay or cancellation will cause any passengers on the passenger lists of such flights to miss a connecting flight. The remote computing device may further detect a length of time and/or a time period until such passengers can travel on another flight. Upon detecting such information for a flight, the remote computing device may identify any passengers on the passenger list of the flight that will miss a connecting flight and/or time in which the passengers will be affected by missing the connecting flight, such as a time until the passengers can depart on another flight. The remote computing device may transmit a virtual card request including identifiers of such passengers to the computing device implementing the systems and methods described herein with metadata regarding the passengers (e.g., the time periods or lengths of time in which the passengers will be affected by the missed connecting flight, a seat status of the passengers, a membership status within the airline of the passengers, etc.). The computer may receive the request and generate virtual cards for the passengers that correspond to use restrictions that correspond to the metadata in the request. The computer may transmit the virtual cards to the remote computing device. Receipt of the virtual cards may cause the remote computing device to transmit the virtual cards to electronic accounts of the passengers, thus enabling the passengers to have virtual cards to use to purchase a hotel room and/or meals while waiting for the next flight. The computer may generate virtual cards in response to any such events. Accordingly, the remote computing device and the computer may cooperate to automatically generate and provision virtual cards with different use restrictions to entities that are affected by an event.

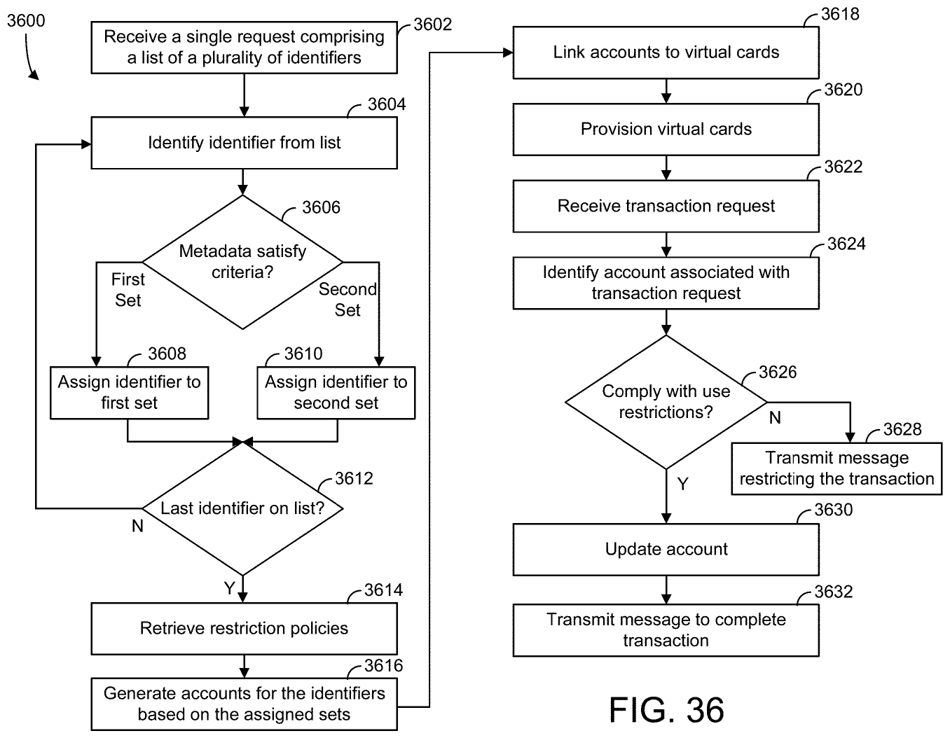

For example, referring now to FIG. 36, an illustration of another method for virtual card generation and provisioning is described, in accordance with an implementation. Method 3600 can be performed by a data processing system (a client device, virtual card generator 104, provisioning device 102, both shown and described with reference to FIG. 1, a server system, etc.). Method 3600 may include more or fewer operations and the operations may be performed in any order. Method 3600 may include the same or similar operations to the operations of methods 200, 226, and/or 242, shown and described with reference to FIGS. 2A-2C. Performance of method 3600 may enable the data processing system to operate as a software-as-a-service system that can receive requests to generate virtual cards, generate the requested virtual cards, and provision the generated virtual cards to the requesting devices. The data processing system may provision an application to a remote computing device to enable method 3600. The data processing system may generate the virtual cards such that the cards may be scanned at point-of-sale terminals or used online to perform transactions. The data processing system may receive a request to generate a virtual card from an external or remote computing system subsequent to the external or remote computing system detecting an event (e.g., a change in data in a database or other data source). The request may include identifiers of individuals for which to generate the virtual card and/or metadata associated with the individuals. The data processing system may determine values or restrictions for the virtual cards based on the metadata and generate accounts (e.g., virtual card accounts) for the individuals that include the values or restrictions. The data processing system may generate and transmit virtual cards to the requesting computing system that correspond to the individual accounts. The data processing system may later receive a notification of a scanned transaction by a virtual card and either approve or restrict (e.g., stop) the transaction from occurring depending on the use restrictions in the virtual card account that corresponds to the virtual card. Accordingly, the data processing system may automatically electronically generate and provision virtual cards in response to bulk requests and control whether to allow transactions to occur via the provisioned virtual cards.

Even though some aspects of method 3600 are described in the context of generating and provisioning virtual cards in response to delayed or canceled flights, it is expressly understood that method 3600 is applicable to generating and provisioning virtual cards for any events.

At operation 3602, the data processing system may receive a request to generate a virtual card for a recipient. The data processing system may receive the request to generate a virtual card from a remote computing device that is owned or accessed by a provisioning entity. A provisioning entity may be a group entity such as a company or organization. Such a provisioning entity may use its computing system (e.g., a remote computing device) to request one or more virtual cards from the data processing system. A virtual card may be, include, or be stored in a data packet that enables users of client devices to make purchases at point-of-sale terminals with the virtual cards using near-field communication technology and/or by providing a code (e.g., a barcode or QR) that can be read by scanners of the point-of-sale terminals.

In one example, the request may be a bulk request for a plurality of virtual cards. The bulk request may be or include a list of a plurality of identifiers and metadata corresponding to individual identifiers of the plurality of identifiers. Each of the plurality of identifiers may correspond to a different entity (e.g., a different individual). The metadata for the identifiers may include descriptions or characteristics of the individuals represented or corresponding to the identifiers. For instance, the identifiers may correspond to individuals that were on a plane flight. Such identifiers may be strings identifying the names of the individuals on the plane flight. The metadata in the request may identify statuses of the individuals on the plane flight. For example, the metadata may indicate whether the individuals sat in “premium” or “general” seats on the flight or whether the individuals are members or non-members of the airlines of the flight. The metadata may indicate any other characteristics about the individuals that correspond to the identifiers.

In some embodiments, the remote computing device may transmit the request to the data processing system in response to the remote computing device detecting an event. For example, the remote computing device may continuously monitor a data source, such as a local or remote database. In doing so, the remote computing device may retrieve values from fields (e.g., values of field-value pairs) of the data source over time. The remote computing device may compare sequentially retrieved values from the same fields while monitoring the data source. Responsive to determining a change in a value of the field, the remote computing device may detect an event. Responsive to detecting the event, the remote computing device may transmit the request for virtual cards to the data processing system.

In some embodiments, the remote computing device may detect the event responsive to determining a criterion was satisfied. The remote computing device may detect a change in values that caused the criterion to be satisfied. For example, the remote computing device may determine a flight for an airline was canceled or delayed. The remote computing device may determine the cancellation or the delay based on a change in status of the flight in a database or the based on the status itself.

The remote computing device may detect an event upon detecting the flight was canceled or delayed or upon detecting a length and/or a time period in which the delay or cancellation affects a passenger satisfies a criterion. For instance, the remote computing device may identify identifiers of the individuals on a delayed or canceled flight from a stored passenger list for the flight. The remote computing device may identify accounts or profiles for the individuals and determine whether the cancellation or delay will result in a missed connecting flight and/or a time period or length of a delay in arriving at the individuals' final destinations or boarding the next departing flight to continue travel to the final destinations. The remote computing device may determine an individual will miss a connecting flight by identifying a time stamp indicating a time in which the individual is schedule to arrive and a timestamp indicating a departure time of the connecting flight, comparing the two timestamps, and determine the individual will miss a connecting flight responsive to the arrival time stamp being after or within a threshold (e.g., a defined threshold) of the departure timestamp.

The remote computing device may determine the time period by querying a database for the next available flight to the individuals' final destinations and/or the next flight of a sequence of flights that will cause the individuals to arrive at their final destinations earliest. The remote computing device may determine the time period is the time period between the arrival time (e.g., an arrival time stamp) of the delayed flight or a flight the individual has to take instead of the canceled flight and a departure time (e.g., a departure time stamp) of the next flight. The remote computing device as the length of the time period. The remote computing device may detect an event when a time period includes certain time frames or time stamps (e.g., the time period is overnight and may result in an individual staying in a hotel) and/or is for a length of time exceeding a threshold, such as a defined threshold (e.g., the time period and/or length of time indicates an individual may have a meal during the length of time and/or time period). The remote computing device may include such time periods and/or lengths of time in the request for virtual cards as metadata.

The remote computing device may detect the event when at least one time period or time length satisfies a criterion. For example, the remote computing device may calculate time periods and/or lengths of time for the identifiers of passengers on the passenger list. The remote computing device may determine whether any identifiers on the list are associated with a time period or length of time that satisfies a criterion (e.g., at least one criterion). Responsive to determining at least one of the identifiers is associated with a time period or length of time that satisfies a criterion, the remote computing device may determine an event occurred and identify the identifier associated with the respective time period or length of time as having a stored association with the event. The remote computing device may similarly identify any other identifiers that are associated with a time period and/or a length of time that satisfies a criterion. The remote computing device may generate a list of such identifiers. In some embodiments, the remote computing device may generate a list of all of the identifiers on the passenger list upon detecting an event for at least one identifier or upon detecting a change in a value or a specific value that has a stored association with the identifiers, such as a status indicating a flight that the entities associated with the identifiers were scheduled to travel on was delayed or canceled.

Upon generating the list of identifiers, the remote computing device may generate a message or request that includes the list of identifiers and/or metadata for the identifiers. The remote computing device may include metadata for the identifiers in the message or request. To do so, in some embodiments, the remote computing device may identify accounts or records for the identifiers from memory of the remote computing device. The remote computing device may retrieve metadata from the identified accounts or records and include the metadata in the message or request. For example, the identifiers on the list of identifiers may be for airline passengers that were affected by a delay or cancellation for a time period or length of time that satisfies one or more criteria. The remote computing device may identify the data structure or accounts that the remote computing device generated when the passengers corresponding to the identifiers booked their tickets. Such data structures and accounts may include characteristics about the passengers such as whether the passengers are members with the airline, whether the passengers had premium or general seats on the canceled or delayed flight, or any other characteristics regarding the passengers. The metadata may be or include the time lengths and/or time periods in which the delay or cancellation affected the passengers (e.g., the time between the arrival time of the flight and the departing times of the next flight the data processing system identified for the passengers). The remote computing device can retrieve such metadata about the passengers and include the retrieved metadata in the request or message with the list of identifiers, in some cases with stored associations with the identifiers. The remote computing device can transmit the request including the list of identifiers and the metadata to the data processing system and the data processing system can receive the request.

At operation 3604, the data processing system identifies an identifier from the list of identifiers. The data processing system may identify the identifier from the list by querying the list of identifiers in the request. The data processing system may identify the first identifier of the list based on the query. In some embodiments, in addition to retrieving the identifier from the list, the data processing system may retrieve metadata that corresponds to or is associated with the identifier from the request. For example, the data processing system may identify metadata (e.g., member, non-member, premium, non-premium, length of time, time period, etc.) in the request that has a stored association (e.g., is on the same line of a table or is otherwise associated) with the retrieved identifier. The data processing system may retrieve the identified metadata from the request.

At operation 3606, the data processing system determines whether the metadata satisfies any criteria (e.g., criteria stored in memory). The criteria may be or include criteria that correspond to different restriction policies. For example, one criterion may be that if the metadata indicates a passenger is a premium member, a first restriction policy will apply, and a second criterion may be that if the metadata indicates a passenger is a general member, a second restriction policy will apply. In another example, a criterion may be that if a passenger time period indicates the passenger is affected by the event for an overnight time period (e.g., between 8 PM and 8 AM) or another defined time period, a third restriction policy will apply, and if a passenger time period indicates the passenger is affected by the event during the day, fourth restriction policy will apply. In yet another example, a criterion may be that if a length of time for a passenger is above within a defined range or exceeds a threshold, a fifth restriction policy will apply, or if a length of time for the passenger is within another range or below the threshold, a sixth restriction policy may apply. The data processing system may also retrieve different restriction policies that correspond to multiple of the above or any other criteria being satisfied. The data processing system may compare the metadata the data processing system retrieves from the request or message to the criteria, determine which criteria are satisfied based on the comparison, if any, and select the restriction policy from memory that corresponds to the different criteria that are satisfied.

Depending on the criteria the data processing system determines the metadata for the identifier satisfies, the data processing system may assign the identifier to different sets of identifiers. For example, responsive to determining the metadata for the identifier satisfies a first criterion, at operations 3608, the data processing system may assign the identifier to a first set of identifiers. Responsive to determining the metadata for the identifiers satisfies a second criterion, at operation 3610, the data processing system may assign the identifier to a second set of identifiers. The data processing system may assign the identifier to the first set of identifiers or the second set of identifiers by labeling the identifier with a label associated with the first set of identifiers or the second set of identifiers, respectively. The data processing system may use the same labels for any other identifiers to group identifiers into the first set of identifiers or the second set of identifiers. The data processing system may similarly group identifiers into any number of sets of identifiers.

At operation 3612, the data processing system determines whether the identifier is the last identifier of the list of identifiers in the request. The data processing system may determine whether the identifier is the last identifier by querying the request for another identifier. If the data processing system identifies another identifier, the data processing system may repeat operations 3604-3612 based on the identified identifier.

However, responsive to determining there is not another identifier on the list of identifiers, at operation 3614, the data processing system retrieves restriction policies that correspond to the sets of identifiers. Restriction policies may be or include values or conditions indicating how or when virtual cards may be used to perform transactions. Values can be maximum values of a single purchase or a maximum value for purchases that can be made in the aggregate using the virtual cards. Conditions may be use restrictions indicating how a virtual card can be used. Conditions may indicate specific locations or types of locations in which virtual cards can be used. Conditions indicating when a virtual card can be used may indicate specific time periods and/or lengths of time in which the virtual card can be used to perform a transaction. For example, a restriction policy may indicate a virtual card can only be used for food or hotel purchases for two hours between the times of 6 PM and 10 PM. Restriction policies may include one or more of such conditions.

The data processing system may retrieve the restriction policies from memory. The data processing system may do so, for example, by identifying the labels of the sets of identifiers and retrieving the restriction policies that correspond to the labels from memory. Accordingly, the data processing system may only retrieve restriction policies that correspond to a request rather than use computing resources to query memory for every stored restriction policy, conserving computer resources.

In some embodiments, the data processing system retrieves restriction policies that correspond to the remote computing device that transmitted the request for virtual cards. For example, the data processing system may store sets of restriction policies that each have restriction policies with different use restrictions and/or values and that correspond to metadata satisfying different conditions. Each set of restriction policies may correspond to different remote computing devices or different entities (e.g., organizations or enterprises). The sets of restriction policies may be configured by the different entities. Responsive to receiving a request for virtual cards, the data processing system may identify the remote computing device that transmitted the request (e.g., the IP address of the remote computing device) or the entity that is associated with (e.g., owns or accesses) the remote computing device and retrieve the restriction policies that correspond to remote computing device or entity from memory.

In some cases, the restriction policies may correspond to different criteria. In such cases, at operation 3606, the data processing system may retrieve the criteria for the set of restriction policies that corresponds to the remote computing device that transmitted the request for virtual cards and apply the criteria to the identifiers to group the identifiers into different sets. Accordingly, different entities can determine how the data processing system can group the identifiers into different sets of identifiers for further processing.

At operation 3616, the data processing system generates virtual card accounts for the identifiers. The virtual card accounts may be or include data structures (e.g., tables or other data structures with field-value pairs). The data processing system may generate the virtual card accounts according to the sets to which the identifiers have been assigned. To do so, for example, for an identifier, the data processing system may identify the set to which the identifier was assigned based on the label associated with the identifier. The data processing system may identify the restriction policy that corresponds to the assigned set. The data processing system may identify and retrieve the values and use restrictions from the restriction policy and insert the retrieved values and use restrictions into the data structure of the virtual card account. As described herein, use restrictions may be the same as or similar to use parameters and vice versa. The data processing system may insert the identifier into the data structure of the virtual card account, thus assigning the identifier to the virtual card account. The data processing system may similarly generate virtual card accounts for each identifier of the list of identifiers to generate sets of virtual card accounts that correspond to the sets of identifiers. Accordingly, the data processing system may insert different values (e.g., maximum transaction values) and/or use restrictions into the data structures of the virtual card accounts based on the sets of identifiers that correspond to the virtual card accounts.

At operation 3618, the data processing system links the virtual card accounts to virtual cards. To do so, the data processing system may generate virtual cards for each of the virtual card accounts the data processing system generated based on the event. The data processing system may generate the virtual cards by using a pseudo-random number generator or another naming technique to generate numeric or alphanumeric identifications for the virtual cards. The data processing system may insert the numeric or alphanumeric identifications for the virtual cards into fields of the data structures of the corresponding virtual card accounts the data processing system generated for the virtual cards. The numeric or alphanumeric identifications for the virtual cards may be pointers or addresses to the virtual cards that uniquely identify the virtual cards. The data processing system may insert a single identifier for a virtual card into each of the virtual card account data structures, thus linking the virtual cards to the virtual card accounts.

At operation 3620, the data processing system provisions the linked virtual cards to the remote computing device. The data processing system may do so by transmitting a data packet to the remote computing device that contains the virtual cards and stored associations between the virtual cards and the identifiers for which the virtual cards were generated. For example, the data processing system may insert the identifications of the virtual cards and/or scannable codes of the virtual cards into a data packet. The data processing system may identify the identifiers that correspond to the identifications of the virtual cards (e.g., the identifiers that correspond to (e.g., are stored in the same data structures as) the same virtual card accounts as the virtual cards). The data processing system may insert the identified identifiers into the data packet. The data processing system may then transmit the data packet containing the virtual cards and identifiers to the remote computing device.

The remote computing device may distribute the virtual cards. To do so, the remote computing device may receive the data packet containing the virtual cards and/or the identifiers that correspond to the virtual cards. The data processing system may retrieve the identifiers and virtual cards from the data packet and identify stored local accounts (e.g., accounts stored in memory of the remote computing device) for the identifiers. For example, the remote computing device may compare the identifiers to the booking information for a flight to identify accounts that were created when the flights were booked and/or the accounts that booked the flight. The remote computing device may compare the identifiers to the accounts and identify the accounts that have matching values to the identifiers. The data processing system may identify and retrieve contact information (e.g., electronic account contact information, such as email address or phone number) from the identified accounts. For each account from which the remote computing device retrieved contact information, the remote computing device may generate a message containing the virtual card that corresponds to the same identifier as the account. In some embodiments, the data processing system may also include the identifier for the individual associated with the account in the message. The remote computing device may generate a message in this way for each virtual card the data processing system generated and provisioned to the remote computing device. The remote computing device may then transmit the messages to the electronic accounts via the contact information the remote computing device retrieved for the messages (e.g., transmit the messages containing the virtual cards to email addresses or phone numbers for which the messages were generated).

At operation 3622, the data processing system receives a transaction request. The transaction request may be a request to perform or facilitate a transaction for a virtual card. The transaction request may include an identifier for the virtual card and transaction data for a transaction (e.g., an identification of the location (e.g., the physical or web-based location), a value or cost of the transaction, an identification of the item or items being purchased in the transaction, an item category or item categories of the items being purchased in the transaction, a time of the transaction, etc.). The data processing system may receive the transaction request from a point-of-sale device or terminal at which the virtual card was scanned or otherwise used to perform or facilitate the transaction.

At operation 3624, the data processing system identifies a virtual card account associated with the transaction request. The data processing system may identify the virtual card account associated with the transaction request by comparing the virtual card identifier included in the transaction request to virtual card identifiers in the data structures of the virtual card accounts stored in memory of the data processing system. The data processing system may identify a data structure that includes a virtual card identifier identical to the virtual card identifier included in the transaction request to identify the virtual card account that is associated with the transaction request.

At operation 3626, the data processing system may determine if the transaction data for the transaction complies with the use restrictions stored in the data structure of the identified virtual card account. To do so, the data processing system may retrieve the use restrictions from the identified data structure for the virtual card account. The data processing system may compare the use restrictions to the transaction data. Responsive to determining the transaction does not violate any of the use restrictions or otherwise complies with each of the use restrictions, the data processing system may determine the transaction complies with the use restrictions for the virtual card account.

For example, the virtual card account may have use restrictions limiting a maximum spend for a transaction to 20 dollars and limiting the type of items that can be purchased to a single meal. The transaction data for the transaction may include a value of 15 dollars and identifications only of food items. The data processing system may determine the items are food items by comparing the identifications of the items being purchased in the transaction to a database (e.g., a relational database) that indicates the types of different items. The data processing system may determine the value of the transaction is less than the maximum spend and the items are being used for a meal based on the transaction data in the transaction request, and therefore determine the transaction complies with the use restrictions for the virtual card account.

In another example, the virtual card account may have use restrictions limiting a maximum spend for a transaction to 300 dollars and limiting the type of items that can be purchased to a hotel room for a single night. The transaction data for the transaction may include a value of 275 dollars and an identification of a location of a grocery store. The data processing system may determine the transaction is taking place at a grocery store by comparing the identification of the location of the transaction to a database (e.g., a relational database) that indicates the types of different locations. The data processing system may determine the transaction is below the transaction limit but that the transaction is being performed at a grocery store instead of a hotel. Therefore, the data processing system may determine the transaction does not comply with the use restrictions of the virtual card account.

Responsive to determining the transaction does not comply with the use restrictions of the virtual card account, at operation 3628, the data processing system transmits a message restricting the transaction. The message may include a string or other identifier indicating a transaction may not be performed. The data processing system may transmit the message to the device (e.g., the point-of-sale device) that transmitted the transaction request to the data processing system. The device that transmitted the message may receive the message and restrict or stop the transaction from being performed accordingly. Thus, the data processing system may restrict individuals from performing transactions that violate use restrictions for the virtual cards being used to perform the transactions.

However, responsive to determining the transaction does comply with the use restrictions of the virtual card account, at operation 3630, the data processing system updates the virtual card account. The data processing system may update the virtual card account by inserting an indication that the virtual card account was used to complete a transaction into the virtual card account or by otherwise incrementing a counter that indicates the number of transactions the virtual card account has been used to complete. In some embodiments, the data processing system may update the virtual card account by subtracting the value of the transaction from a value (e.g., a maximum spend limit) in the data structure of the virtual card account to obtain a new or remaining value in the data structure of the virtual card account. The data processing system may update the virtual card account in any manner.

The new values or counts may operate as new use restrictions the data processing system may use to determine whether to enable another transaction. For example, the maximum spend limit may indicate a maximum value of purchases for which the virtual card may be used in the aggregate. The data processing system may subtract the value of a transaction from the maximum spend limit to obtain a new or remaining maximum spend limit. Any future purchases performed with the same virtual card may not have a value that exceeds the new or remaining maximum spend limit. In another example, the virtual card may have a use restriction indicating a maximum number of transactions that may be performed with the virtual card. The data processing system may increment a counter for each transaction for which the virtual card is used until reaching a stored maximum value. Upon the count of the counter reaching the maximum number of transactions, the data processing system may restrict the virtual card from being used for any further transactions. In this way, the data processing system may continuously update the data structures of virtual card accounts with use restrictions to enable or restrict virtual cards associated with the virtual card accounts from being used to perform transactions.

In some embodiments, the use restrictions for a virtual card account may be modified by an administrator (e.g., a user accessing the remote computing device for which the virtual card account was generated and a virtual card provisioned). For example, the remote device that caused the data processing system to generate the virtual card account may transmit a modification request to the data processing system with one or more identifiers. The one or more identifiers may be the same as or a subset of the identifiers for which the remote computing device detected an event and transmitted a request for the data processing system to generate one or more virtual cards. The modification request may include use restrictions similar to the use restrictions described above. The data processing system may receive the modification request from the remote computing device, identify the virtual card accounts that correspond to the identifiers in the modification request, and insert the use restrictions from the modification request into the identified virtual card accounts. In instances in which the use restrictions in the modification request are of the same restriction type as use restrictions in the virtual card accounts, the data processing system may adjust or replace the use restrictions in the data structures for the virtual card accounts with the corresponding use restrictions in the modification request. Accordingly, the data processing system may use the virtual card account data structures to enable computing devices to customize the use restrictions for virtual cards in real time.

At operation 3632, the data processing system transmits a message to the device to complete the transaction. The data processing system may transmit the message to the device to complete the transaction responsive to determining the transaction complies with the use restrictions of the virtual card account. The message may include a string or another identifier that indicates the transaction can be completed. The device may receive the message indicating the transaction can be completed and perform or facilitate the transaction.

In some embodiments, the data processing system may store values in virtual card accounts that are in different formats than the values for transactions the data processing system receives in transaction requests. In such embodiments, when the data processing system receives a transaction request with a value for a transaction in a first format, the data processing system may convert the value for the transaction into a second format that matches the format of the value in the virtual card account that corresponds to the virtual card for which the transaction request was sent. For example, the data processing system may store a virtual card account with a maximum spend limit in airline points or miles. The data processing system may receive a transaction request from a virtual card that corresponds to the virtual card account with a transaction value in U.S. dollars. The data processing system may convert the transaction value for the transaction from U.S. dollars to airline points or miles. The data processing system may do so, for example, by multiplying the transaction value by a stored conversion factor. In some cases, the data processing system may store different conversion factors for different provisioning entities. In such cases, the data processing system may retrieve the stored conversion factor for the transaction based on the conversion factor having a stored association in memory with an identifier of the provisioning entity (e.g., the remote computing device) that generated and provisioned the virtual card being used in the transaction. The data processing system may subtract the converted transaction value from the stored maximum spend limit in the virtual card account to obtain a remaining value, in some embodiments upon determining the transaction complies with or does not violate any use restrictions in the virtual card account. The data processing system may transmit the remaining value to the remote computing device for which the virtual card was provisioned.

The remote computing device may receive the remaining value from the data processing system and update, based on the remaining value, a stored corresponding account to the virtual card account for the virtual card stored at the data processing system. For example, the virtual card account for the virtual card stored at the data processing system may correspond to (e.g., be associated with or owned by the same entity or individual) an account stored in memory of the remote computing device. The remote computing device may receive the remaining value and store the remaining value in the account stored in memory of the remote computing device such that the individual associated with the account may use the remaining value to make purchases. In instances in which the account stored at the remote computing device has a data structure in which a value is already stored with the same format, the remote computing device may update the value by aggregating the stored value with the remaining value, thus updating the account in real-time based on transactions the data processing system facilitates through the virtual card the data processing system provisioned to the remote computing device.

In some embodiments, the data processing system may update restriction policies based on transaction data of transactions the data processing system receives in transaction requests. For example, the data processing system may store a database that includes transaction data of historical or previous transactions. The data processing system may add transaction data to the database over time as the data processing system receives new transaction requests. The data processing system may calculate a predicted transaction value from historical transaction values stored in the database and a transaction value the data processing system retrieved from a transaction request. For example, upon receiving a transaction request for a transaction, the data processing system may retrieve the transaction value (e.g., the cost of the transaction) from the transaction request and historical transaction values from the database. The data processing system may generate a feature vector from the transaction value and historical transaction values. The data processing system may input the feature vector into a machine learning model (e.g., a neural network, support vector machine, random forest, etc.) and execute the machine learning model, causing the machine learning model to output a predicted transaction value based on the execution. In another example, the data processing system may calculate an average or median of the transaction value from the transaction request and the historical transaction values to calculate the predicted transaction value.

The data processing system may update a restriction policy based on the predicted transaction value. For example, the data processing system may identify the restriction policy associated with the virtual card account stored in memory of the data processing system that is associated with the transaction request (e.g., the restriction policy associated with the set of virtual card accounts including the virtual card account that were generated upon the remote computing device detecting an event). The data processing system may identify the data structure that includes values and/or use parameters for the restriction policy. The data processing system may replace the value in the data structure with the predicted transaction value and/or a modification of the predicted transaction value (e.g., the predicted transaction value plus or minus a defined value or percentage of the predicted transaction value). The data processing system may similarly update the restriction policy and other restriction policies stored in memory over time as the data processing system receives further transaction requests. Accordingly, the data processing system may maintain up-to-date restriction policies that account for changes in human behavior and/or economic factors (e.g., price changes).

In some cases, the data processing system may transmit the predicted transaction value or the modified predicted transaction value to the remote computing device. The data processing system may do so to enable users of the remote computing device to view the change and/or determine whether and/or how to modify the use parameters of virtual card accounts or restriction policies stored at the data processing system.

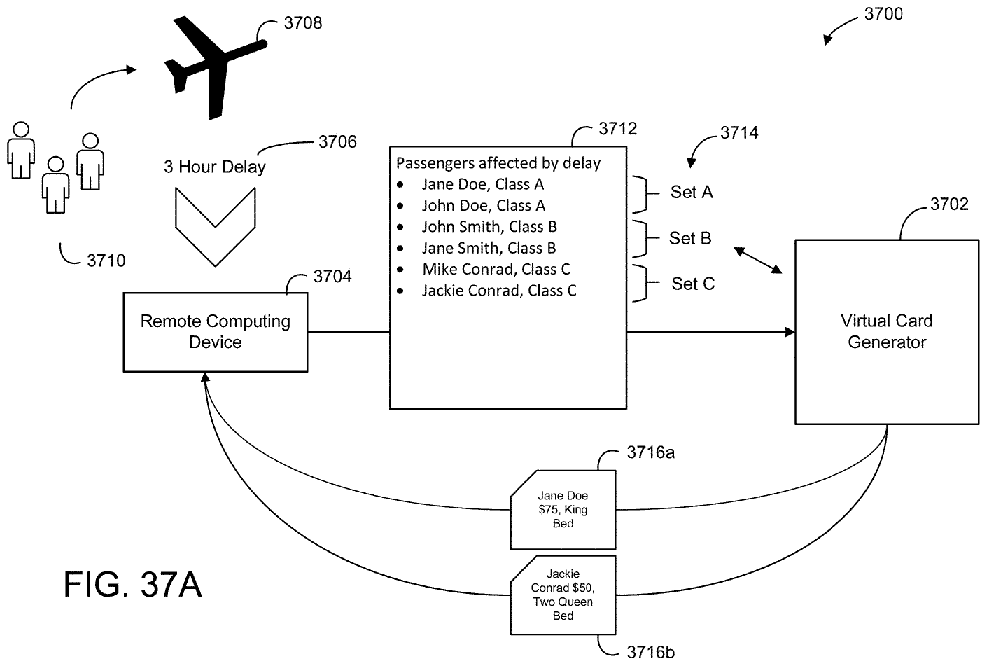

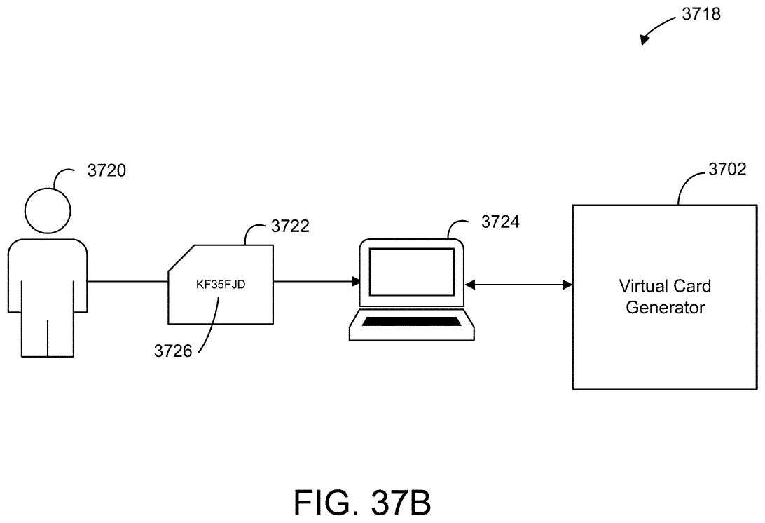

Referring now to FIG. 37A, a sequence 3700 for managing bulk requests for virtual cards is described, in accordance with one or more implementations. Sequence 3700 can be performed by a virtual card generator 3702 and/or a remote computing device 3704, which may be the same as or similar to virtual card generator 104 and/or provisioning device 102, both shown and described with reference to FIG. 1. Sequence 3700 may include more or fewer components and operations and the operations may be performed in any order.

In sequence 3700, remote computing device 3704 may detect an event. The event may be, for example, a three-hour delay 3706 of a flight 3708. The remote computing device 3704 may detect the event by monitoring a database that stores different information about the statuses of flights performed by an airline that owns or accesses remote computing device 3704. Upon detecting three-hour delay 3706, remote computing device 3704 may analyze the passenger list (e.g., a record stored in memory of the passengers of flight 3708) for passengers that are on the flight that will be affected by three-hour delay 3706. Remote computing device 3704 may do so, for example, by identifying the bookings of the passengers (e.g., identifying bookings that have matching identifiers (e.g., names) of the passengers to the identifiers of the passengers on the passenger list) and identifying times of any connecting flights. Remote computing device 3704 may identify any connecting flights that take off within the time period of three-hour delay 3706 or within a time threshold of three-hour delay 3706 (e.g., the connecting flight takes off after flight 3708 will land but there will not be enough time for a passenger to travel from flight 3708 to the connecting flight before the connecting flight takes off). Remote computing device 3704 may identify any individuals that will miss a connecting flight as entities 3710 that were affected by three-hour delay 3706.

Upon identifying entities 3710, remote computing device 3704 may determine or calculate time periods and/or lengths of time for which entities 3710 will be affected by three-hour delay 3706. Remote computing device 3704 may do so by querying (e.g., automatically querying upon identifying entities 3710) a database for connecting flights to the final destinations of entities 3710 with take-off timestamps (e.g., departure times) closest to a time in which flight 3708 arrived or is scheduled to arrive. Remote computing device 3704 may identify the final destinations of entities 3710 from the stored bookings or accounts of entities 3710 in a database. In querying the database for connecting flights to the final destinations, remote computing device 3704 may identify single connecting flights and/or flights with one or more layovers to arrive at the final destinations. Remote computing device 3704 may filter through the connecting flights according to an optimization function minimizing the length of time and/or time period between the landing time of delayed flight 3708 and departure times of connecting flights while minimizing the arrival times of the connecting flights at the final destinations. Remote computing device 3704 may identify connecting flights in this way for each of entities 3710 and identify the time periods and/or lengths of times of the time periods between the landing time of flight 3708 and the departure times of each of the connecting flights for each of entities 3710.

Remote computing device 3704 may generate a bulk request 3712 for virtual cards. Remote computing device 3704 may generate bulk request 3712 by inserting identifiers (e.g., names) of entities 3710 into bulk request 3712. Remote computing device 3704 may also retrieve metadata (e.g., member, non-member, premium, non-premium, etc.) regarding entities 3710 from the bookings or accounts of entities 3710. In one example, remote computing device 3704 may retrieve seat numbers and/or seat status (e.g., first class, business class, economy, etc.) of entities 3710 on flight 3708 as metadata from the bookings or accounts of entities 3710. Remote computing device 3704 may insert the retrieved metadata as well as the calculated or determined lengths of time and/or time periods for entities 3710 as metadata into request 3712 with stored associations between the metadata and the identifiers of entities 3710 to which the metadata corresponds. Remote computing device 3704 may transmit request 3712 to virtual card generator 3702.

Virtual card generator 3702 may receive request 3712 and group the identifiers of entities 3710 into sets of identifiers 3714. Virtual card generator 3702 may group the identifiers of entities 3710 into sets of identifiers 3714 based on the metadata for each identifier. For example, as illustrated in sequence 3700, virtual card generator 3702 may group Jane Doe and John Doe into Set A because Jane Doe and John Doe each had Class A seats on flight 3708, John Smith and Jane Smith into Set B because John Smith and Jane Smith each had Class B seats on flight 3708, and Mike Conrad and Jackie Conrad into Set C because Mike Conrad and Jackie Conrad each had Class C seats on flight 3708. Virtual card generator 3702 may group identifiers into any number of sets of identifiers and/or based on any criteria. By doing so, virtual card generator 3702 may group the identifiers into sets that each correspond to different use restrictions and/or maximum transaction values.

Virtual card generator 3702 may retrieve restriction policies that correspond to sets 3714. For example, virtual card generator 3702 may store restriction policies that correspond to different sets of identifiers. Each restriction policy may be or include a data structure (e.g., a table or a row in a table) with different use parameters and/or maximum transaction values (e.g., single maximum transaction values and/or maximum transaction values for transaction in the aggregate). Virtual card generator 3702 may identify the sets of identifiers 3714 and retrieve the restriction policies from memory that correspond to the identified sets.

Virtual card generator 3702 may generate a virtual card account for each identifier of the request 3712. The virtual card accounts may be, include, or correspond to data structures with field-value pairs for different attributes of the virtual card accounts. Virtual card generator 3702 may generate a virtual card account for an identifier of request 3712 by inserting the identifier into the data structure of the virtual card account. Virtual card generator 3702 may also identify the use restrictions and/or the maximum transaction value of the restriction policy that corresponds to the set of identifiers of the identifier and insert the identified use restrictions and/or the maximum transaction value into the data structure of the virtual card account. Virtual card generator 3702 may similarly generate virtual card accounts for each identifier of request 3712.

Virtual card generator 3702 may generate virtual cards for the identifiers of request 3712. Virtual card generator 3702 may generate the virtual cards by generating a numeric or alphanumeric value for each identifier (e.g., generate numeric or alphanumeric values using a random number generator). Virtual card generator 3702 may also generate unique scannable bar codes for each virtual card. Virtual card generator 3702 may link the virtual cards to the virtual card accounts by inserting the generated numeric or alphanumeric values for the virtual cards into virtual card field-value pairs of the data structures of the respective virtual card accounts for which the virtual cards were generated. Virtual card generator 3702 may transmit the virtual cards for entities 3710 (e.g., virtual cards 3716a-b) to remote computing device 3704 in one or more data packets, in some cases with identifications of the use restrictions and/or maximum transaction limits of each virtual card.

Remote computing device 3704 may receive the virtual cards from virtual card generator 3702 and provision the virtual cards to electronic accounts (e.g., phone numbers or email addresses) of entities 3710. Remote computing device 3704 may do so by identifying the electronic account information for entities 3710 from stored accounts or the bookings of flight 3708 for entities 3710. Remote computing device 3704 may transmit the virtual cards to the electronic accounts of entities 3710 that correspond to the respective virtual cards.

Referring now to FIG. 37B, a sequence 3718 for processing a transaction performed with a virtual card is described, in accordance with one or more implementations. Sequence 3718 can be performed by virtual card generator 3702 and/or remote computing device 3704, which may be the same as or similar to virtual card generator 104 and/or provisioning device 102, both shown and described with reference to FIG. 1. Sequence 3718 may include more or fewer components and operations and the operations may be performed in any order.

In sequence 3718, virtual card generator 3702 may monitor transactions performed by an entity 3720 of entities 3710 using a provisioned virtual card 3722. Virtual card generator 3702 may do so to ensure a transaction for which virtual card 3722 complies with use restrictions of virtual card 3722. For example, when an entity 3710 uses provisioned virtual card 3722 for a transaction at a point-of-sale terminal 3724 (e.g., a computer configured to facilitate transactions) or online, point-of-sale terminal 3724 or the online computer (not shown) that is processing the transaction may identify an address of virtual card generator 3702 from the virtual card and transmit a message to virtual card generator 3702 containing a numeric or alphanumeric identifier 3726 of virtual card 3722 and a location identifier of a physical location of point-of-sale terminal 3724 (e.g., the location of the brick-and-mortar store in which point-of-sale terminal 3724 is located) or a web address (e.g., a uniform resource locator) of the website in which virtual card 3722 is being used. In some cases, point-of-sale terminal 3724 may also transmit identifications of any items that are being purchased in the transaction. Virtual card generator 3702 may receive the message and compare identifier 3726 of virtual card 3722 to stored virtual card identifiers in stored virtual card accounts to identify a virtual card account that corresponds to virtual card 3722, which is being used in the transaction. Virtual card generator 3702 may retrieve the use restrictions from the identified virtual card account and compare the identification of the location and/or identifications of the items to the use restrictions to determine if the transaction violates (e.g., the transaction data violates) any of the use restrictions.

Virtual card generator 3702 may enable or restrict the transaction based on whether the transaction complies with the use restrictions in the virtual card account. Responsive to determining the transaction violates any of the use restrictions, virtual card generator 3702 may transmit a message to point-of-sale terminal 3724 indicating to not enable the transaction. Point-of-sale terminal 3724 may generate an alert (e.g., an auditory or virtual alert indicating the transaction was denied) responsive to receiving the message from virtual card generator 3702. The message may control the point-of-sale terminal 3724 to not perform or process the transaction. Responsive to determining the transaction complies with the use restrictions, virtual card generator 3702 may transmit a message to point-of-sale terminal 3724 indicating to enable the transaction. Point-of-sale terminal 3724 may generate an alert (e.g., an auditory or virtual alert indicating the transaction was denied) responsive to receiving the message from virtual card generator 3702. The message may control the point-of-sale terminal 3724 to perform or process the transaction. When determining the transaction complies with the use restrictions of the virtual card account, virtual card generator 3702 may update the use restrictions in the virtual card account such as by incrementing a counter to indicate the number of transactions for which the virtual card has been used and/or by subtracting the value of the transaction from the maximum transaction limit of the virtual card to obtain a remaining maximum transaction limit for the virtual card. Accordingly, virtual card generator 3702 may update and manage virtual cards for different entities in real time, ensuring any transactions for which the virtual cards are being performed comply with use restrictions.

The subject matter and the operations described in this specification can be implemented in digital electronic circuitry, or in computer software, firmware, or hardware, including the structures disclosed in this specification and their structural equivalents, or in combinations of one or more of them. The subject matter described in this specification can be implemented as one or more computer programs, e.g., one or more circuits of computer program instructions, encoded on one or more computer storage media for execution by, or to control the operation of, data processing apparatuses. A computer storage medium can be, or be included in, a computer-readable storage device, a computer-readable storage substrate, a random or serial access memory array or device, or a combination of one or more of them. While a computer storage medium is not a propagated signal, a computer storage medium can be a source or destination of computer program instructions encoded in an artificially generated propagated signal. The computer storage medium can also be, or be included in, one or more separate components or media (e.g., multiple CDs, disks, or other storage devices). The operations described in this specification can be implemented as operations performed by a data processing apparatus on data stored on one or more computer-readable storage devices or received from other sources.

The terms “computing device” or “component” encompass various apparatuses, devices, and machines for processing data, including by way of example a programmable processor, a computer, a system on a chip, or multiple ones, or combinations of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, app, script, or code) can be written in any form of programming language, including compiled or interpreted languages, declarative or procedural languages, and can be deployed in any form, including as a stand-alone program or as a module, component, subroutine, object, or other unit suitable for use in a computing environment. A computer program can correspond to a file in a file system. A computer program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs (e.g., components of the client devices 106 and/or 108 or virtual card generator 104) to perform actions by operating on input data and generating output. The processes and logic flows can also be performed by, and apparatuses can also be implemented as, special purpose logic circuitry, e.g., an FPGA (field programmable gate array) or an ASIC (application specific integrated circuit). Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks. The processor and the memory can be supplemented by, or incorporated in, special purpose logic circuitry.

While operations are depicted in the drawings in a particular order, such operations are not required to be performed in the particular order shown or in sequential order, and all illustrated operations are not required to be performed. Actions described herein can be performed in a different order. The separation of various system components does not require separation in all implementations, and the described program components can be included in a single hardware or software product.

The phraseology and terminology used herein is for the purpose of description and should not be regarded as limiting. Any references to implementations or elements or acts of the systems and methods herein referred to in the singular may also embrace implementations including a plurality of these elements, and any references in plural to any implementation or element or act herein may also embrace implementations including only a single element. Any implementation disclosed herein may be combined with any other implementation or embodiment.

References to “or” may be construed as inclusive so that any terms described using “or” may indicate any of a single, more than one, and all of the described terms. References to at least one of a conjunctive list of terms may be construed as an inclusive OR to indicate any of a single, more than one, and all of the described terms. For example, a reference to “at least one of ‘A’ and ‘B’” can include only ‘A’, only ‘B’, as well as both ‘A’ and ‘B’. Such references used in conjunction with “comprising” or other open terminology can include additional items.

The foregoing implementations are illustrative rather than limiting of the described systems and methods. Scope of the systems and methods described herein is thus indicated by the appended claims, rather than the foregoing description, and changes that come within the meaning and range of equivalency of the claims are embraced therein.

What is claimed is:

1. A method for virtual card generation and provisioning, the method comprising:
receiving, by a processor from a remote computing device, a single request comprising a list of a plurality of identifiers corresponding to a plurality of entities and metadata corresponding to the plurality of identifiers, the remote computing device transmitting the single request to the processor in response to the remote computing device:
detecting an event based on data stored in a data source, and
determining each of the plurality of identifiers has a stored association with the data based on which the remote computing device detected the event;
parsing, by the processor from the single request and based on the metadata corresponding to the plurality of identifiers, the list of the plurality of identifiers into a first set of identifiers and a second set of identifiers;
retrieving, by the processor from a computer memory, a first restriction policy corresponding to the first set of identifiers and a second restriction policy corresponding to the second set of identifiers;
generating, by the processor, a plurality of virtual cards for the plurality of entities by:
generating, by the processor, a first set of accounts for the first set of identifiers according to the first restriction policy by inserting a first value and a first use restriction into a data structure of each of the first set of accounts, and a second set of accounts for the second set of identifiers according to the second restriction policy by inserting a second value different from the first value and a second use restriction different from the first use restriction into a data structure of each of the second set of accounts; and
linking, by the processor, a first set of virtual cards of the plurality of virtual cards to corresponding accounts of the first set of accounts and a second set of virtual cards of the plurality of virtual cards to corresponding accounts of the second set of accounts; and
provisioning, by the processor, the generated plurality of virtual cards to the remote computing device, receipt of the generated plurality of virtual cards causing the remote computing device to transmit the plurality of virtual cards to computing devices associated with the plurality of entities.

2. The method of claim 1, wherein parsing the list of the plurality of identifiers into the first set of identifiers and the second set of identifiers based on the metadata corresponding to the plurality of identifiers comprises:
identifying, by the processor, an identifier type of each of the plurality of identifiers from the metadata; and
assigning, by the processor, the plurality of identifiers into the first set of identifiers and the second set of identifiers based on the identified identifier type of each of the plurality of identifiers.

3. The method of claim 2, wherein identifying the identifier type of each of the plurality of identifiers comprises identifying, by the processor, identifiers having a first type from the plurality of identifiers and identifiers having a second type from the plurality of identifiers; and wherein assigning the plurality of identifiers into the first set of identifiers and the second set of identifiers comprises labeling, by the processor, the identifiers having the first type with a first label and the identifiers having the second type with the second label.

4. The method of claim 1, wherein linking a virtual card of the first set of virtual cards to a corresponding account of the first set of accounts comprises storing, by the processor, a pointer to the virtual card in a data structure of the corresponding account to the virtual card.

5. The method of claim 1, wherein generating the first set of accounts for the first set of identifiers according to the first restriction policy comprises:
inserting, by the processor, a location identifier identified in the first restriction policy into the data structure of each of the first set of accounts, the location identifier indicating a location or a location type in which the first set of virtual cards can be used.

6. The method of claim 5, further comprising:
receiving, by the processor, a transaction request for a transaction from a computer, the transaction request comprising an identifier of a virtual card and an identification of a first location;
determining, by the processor, the identifier of the transaction request matches an identifier stored in a first data structure of a first account of the first set of accounts; and
responsive to determining the identification of the first location does not match the location identifier stored in the first data structure, transmitting, by the processor, a message to the computer restricting the transaction.

7. The method of claim 5, further comprising:
receiving, by the processor, a transaction request for a transaction from a computer, the transaction request comprising an identifier of a virtual card and an identification of a first location;
determining, by the processor, the identifier of the transaction request matches an identifier stored in a first data structure of a first account of the first set of accounts; and
responsive to determining the identification of the first location matches the location identifier stored in the first data structure, transmitting, by the processor, a message to the computer indicating to complete the transaction.

8. The method of claim 1, further comprising:
receiving, by the processor, a transaction request for a transaction from a computer, the transaction request comprising an identifier of a virtual card, and a transaction value;
determining, by the processor, the identifier of the transaction request matches an identifier stored in a first data structure of a first account of the first set of accounts; and
subtracting, by the processor, the transaction value from a first value stored in the first data structure responsive to determining the transaction complies with the first use restriction of the first account.

9. The method of claim 8, wherein the first value is in a first format and the transaction value is in a second format, wherein subtracting the transaction value from the first value stored in the first data structure comprises:
converting, by the processor, the transaction value from the second format to the first format; and
subtracting the converted transaction value in the first format from the first value in the first format.

10. The method of claim 9, wherein subtracting the converted transaction value in the first format from the first value in the first format generates a remaining value in the first data structure, further comprising:
transmitting, by the processor, the remaining value to the remote computing device.

11. The method of claim 8, further comprising:
calculating, by the processor, a predicted transaction value based on the transaction value and one or more historical transaction values received in historical transaction requests; and
updating, by the processor, the first restriction policy based on the predicted transaction value.

12. The method of claim 11, wherein calculating the predicted transaction value comprises:
generating, by the processor, a feature vector comprising the transaction value and the one or more historical transaction values; and
executing, by the processor, a machine learning model using the transaction value and the one or more historical transaction values as input to generate the predicted transaction value.

13. The method of claim 8, further comprising:
calculating, by the processor, a predicted transaction value based on the transaction value and one or more historical transaction values received in historical transaction requests; and
transmitting, by the processor, the predicted transaction value to the remote computing device.

14. The method of claim 1, wherein the first value is higher than the second value.

15. The method of claim 1, wherein generating the plurality of virtual cards comprises generating, by the processor, a plurality of numerical identifiers; wherein linking the first set of virtual cards of the plurality of virtual cards to corresponding accounts of the first set of accounts comprises storing, by the processor, first numerical identifiers of the plurality of numerical identifiers in data structures of the first set of accounts; and wherein provisioning the generated plurality of virtual cards to the remote computing device comprises transmitting, by the processor, the first numerical identifiers to the remote computing device.

16. The method of claim 1, wherein parsing the list of the plurality of identifiers into the first set of identifiers and the second set of identifiers based on the metadata corresponding to the plurality of identifiers comprises:
identifying, by the processor, time periods or lengths of time in which the plurality of entities will be affected by the event from the metadata; and
assigning, by the processor, the plurality of identifiers into the first set of identifiers and the second set of identifiers based on the identified time periods or lengths of time for the plurality of entities corresponding to the plurality of identifiers.

17. The method of claim 1, further comprising:
receiving, by the processor, a request comprising a third value, a third use restriction, and an identification of an account of the first set of accounts, the data structure of the account comprising the first value and the first use restriction; and
in response to receiving the request, adjusting, by the processor, the first value in the data structure of account to the third value and the first use restriction of the data structure of the account into the third use restriction.

18. A system, the system comprising:
one or more processors configured by machine-readable instructions to:
receive, from a remote computing device, a single request comprising a list of a plurality of identifiers corresponding to a plurality of entities and metadata corresponding to the plurality of identifiers, the remote computing device transmitting the single request to the one or more processors in response to the remote computing device:
detecting an event based on data stored in a data source, and
determining each of the plurality of identifiers has a stored association with the data based on which the remote computing device detected the event;
parse, from the single request and based on the metadata corresponding to the plurality of identifiers, the list of the plurality of identifiers into a first set of identifiers and a second set of identifiers;
retrieve, from a computer memory coupled to the one or more processors, a first restriction policy corresponding to the first set of identifiers and a second restriction policy corresponding to the second set of identifiers;
generate a plurality of virtual cards for the plurality of entities by:
generating a first set of accounts for the first set of identifiers according to the first restriction policy by inserting a first value and a first use restriction into a data structure of each of the first set of accounts, and a second set of accounts for the second set of identifiers according to the second restriction policy by inserting a second value different from the first value and a second use restriction different from the first use restriction into a data structure of each of the second set of accounts; and
linking a first set of virtual cards of the plurality of virtual cards to corresponding accounts of the first set of accounts and a second set of virtual cards of the plurality of virtual cards to corresponding accounts of the second set of accounts; and
provision the generated plurality of virtual cards to the remote computing device, receipt of the generated plurality of virtual cards causing the remote computing device to transmit the plurality of virtual cards to computing devices associated with the plurality of entities.

19. The system of claim 18, wherein the one or more processors are configured to parse the list of the plurality of identifiers into the first set of identifiers and the second set of identifiers based on the metadata corresponding to the plurality of identifiers by:
identifying an identifier type of each of the plurality of identifiers from the metadata; and
assigning the plurality of identifiers into the first set of identifiers and the second set of identifiers based on the identified identifier type of each of the plurality of identifiers.

20. A non-transitory computer-readable storage medium having instructions embodied thereon, the instructions being executable by one or more processors to perform a method, the method comprising:
receiving, from a remote computing device, a single request comprising a list of a plurality of identifiers corresponding to a plurality of entities and metadata corresponding to the plurality of identifiers, the remote computing device transmitting the single request to the one or more processors in response to the remote computing device:
detecting an event based on data stored in a data source, and
determining each of the plurality of identifiers has a stored association with the data based on which the remote computing device detected the event;
parsing, from the single request and based on the metadata corresponding to the plurality of identifiers, the list of the plurality of identifiers into a first set of identifiers and a second set of identifiers;
retrieving, from a computer memory, a first restriction policy corresponding to the first set of identifiers and a second restriction policy corresponding to the second set of identifiers;
generating a plurality of virtual cards for the plurality of entities by:
generating a first set of accounts for the first set of identifiers according to the first restriction policy by inserting a first value and a first use restriction into a data structure of each of the first set of accounts, and a second set of accounts for the second set of identifiers according to the second restriction policy by inserting a second value different from the first value and a second use restriction different from the first use restriction into a data structure of each of the second set of accounts; and
linking a first set of virtual cards of the plurality of virtual cards to corresponding accounts of the first set of accounts and a second set of virtual cards of the plurality of virtual cards to corresponding accounts of the second set of accounts; and
provisioning the generated plurality of virtual cards to the remote computing device, receipt of the generated plurality of virtual cards causing the remote computing device to transmit the plurality of virtual cards to computing devices associated with the plurality of entities.
